(19) United States
(12) Patent Application Publication
(10) Pub. No.: US 2022/0349679 A1
(43) Pub. Date: Nov. 3, 2022

(54) POROUS BALLISTIC ARMOR

(71) Applicant: SAINT-GOBAIN CERAMICS & PLASTICS, INC., Worcester, MA (US)

(72) Inventor: Diana R. TIERNEY, Lewiston, NY (US)

(21) Appl. No.: 17/652,221

(22) Filed: Feb. 23, 2022

Related U.S. Application Data
(60) Provisional application No. 63/152,632, filed on Feb. 23, 2021.

(51) Int. Cl. F41H 5/04; C04B 38/00

(52) U.S. Cl. CPC F41H 5/0414; C04B 38/0054; C04B 38/0061

(57) ABSTRACT

An article includes a body having a first phase comprising alpha silicon carbide and pores contained in the body; the pores having a mean spacing distance of at least 205 microns and not greater than 300. The body can have a ballistic.

### CROSS-REFERENCE TO RELATED APPLICATION(S)

This application claims priority under 35 U.S.C. § 119(e) to U.S. Provisional Application No. 63/152,632, entitled “POROUS BALLISTIC ARMOR,” by Diana R. TIERNEY, filed Mar. 23, 2021, which is assigned to the current assignee hereof and incorporated herein by reference in its entirety.

### FIELD OF THE DISCLOSURE

The present disclosure relates to materials for ballistic armor.

### Related Art

Silicon carbide is a known material that is suitable for a variety of uses because of its properties. The most notable uses for silicon carbide include refractory uses.

### BRIEF DESCRIPTION OF THE DRAWINGS

Embodiments are illustrated by way of example and are not limited in the accompanying figures.

FIGS. 1 and 2 include cross-sections of a porous material in accordance with an embodiment.

FIG. 3 includes a distribution of the distances between pores of a porous material in accordance with an embodiment and a comparative sample.

FIG. 4 includes a cumulative distribution of the distances between pores of a porous material in accordance with an embodiment and a comparative sample.

FIG. 5 includes a perspective illustration of a portion of an armor component in accordance with an embodiment.

FIG. 6 includes a cross-sectional illustration of a portion of an armor component in accordance with an embodiment.

FIG. 7 includes a cross-sectional illustration of a portion of an armor component in accordance with an embodiment.

### DETAILED DESCRIPTION

The following description in combination with the figures is provided to assist in understanding the teachings disclosed herein. The following discussion will focus on specific implementations and embodiments of the teachings. Other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all other technical and scientific terms used herein have the same meaning as commonly understood by one of ordinary skill in the art to which this invention belongs. The materials, methods, and examples are illustrative only and not intended to be limiting.

The following embodiments are generally directed to a porous material for ballistic armor.

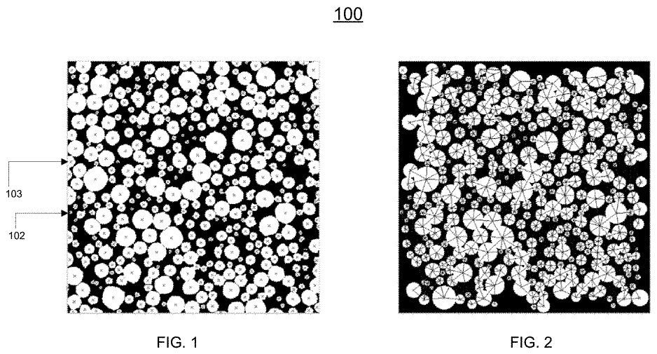

FIG. 1 includes a cross-sectional illustration of a portion of an article 100 according to an embodiment. The article 100 can include a body 101. The body 101 may include a first phase 102 and pores 103 contained in the body 101.

The process for forming the article can include making a mixture of raw materials. The mixture may be wet or dry, but dry may be preferred in certain instances. The mixture may include one or more pore forming materials. The pore forming materials may be sorted and sized for shape and particle size distribution. The size, shape, and content of the pore forming materials may be controlled to control aspects of the microstructure, such as the porosity of the microstructure in the finally-formed article. After creating the mixture, the mixture may be shaped into a green body.

A green body refers to a body that may undergo further processing to form the finally-formed article. For example, the green body may be sintered at a temperature suitable to form the article having any of the features of the embodiments herein. In an embodiment, the green body may be sintered at a sintering temperature of at least 1500° C. or at least 1600° C. or at least 1700° C. or at least 1750° C. or at least 1800° C. or at least 1850° C. or at least 1900° C. or at least 1950° C. or at least 2000° C. or at least 2025° C. or at least 2050° C. or at least 2075° C. or at least 2100° C. or at least 2125° C. In another embodiment, the green body may be sintered at a sintering temperature of no greater than 2500° C., such as no greater than 2450° C. or no greater than 2400° C. or no greater than 2350° C. or no greater than 2300° C. or no greater than 2250° C. or no greater than 2200° C. It will be appreciated that the green body may be sintered at a sintering temperature between any of the minimum and maximum values noted above, including for example, but not limited to, at least 1500° C. and no greater than 2350° C., such as within a range of at least 1750° C. and no greater than 2500° C. or within a range of at least 1850° C. and no greater than 2400° C.

In an embodiment, the green body may be sintered at the sintering temperature for a particular amount of time that may facilitate improved performance or manufacturing of the article. In an embodiment, the green body may be sintered at the sintering temperature for at least 30 minutes or at least 45 minutes or at least 60 minutes or at least 75 minutes or at least 90 minutes or at least 105 minutes or at least 120 minutes or at least 135 minutes or at least 150 minutes. In an embodiment, the green body may be sintered at the sintering temperature for no greater than 600 minutes or no greater than 570 minutes or no greater than 540 minutes or no greater than 510 minutes or no greater than 480 minutes or no greater than 450 minutes or no greater than 420 minutes or no greater than 390 minutes or no greater than 360 minutes or no greater than 330 minutes or no greater than 300 minutes or no greater than 270 minutes or no greater than 240 minutes. It will be appreciated that the green body may be sintered at a maximum temperature for a period of time between any of the minimum and maximum values noted above, including for example, but not limited to, within a range of at least 30 minutes and no greater than 600 minutes or within a range of at least 45 minutes and no greater than 300 minutes or within a range of at least 105 minutes and no greater than 240 minutes.

In an embodiment, the body can comprise a particular content of SiC that may facilitate improved manufacturing and/or performance of the article. For example, in one embodiment, the body can include at least 90 wt. % SiC for a total weight of the body, such as at least 91 wt. % or at least 92 wt. % or at least 93 wt. % or at least 94 wt. % or at least 95 wt. %, or at least 96 wt. %, or at least 97 wt. %, or at least 98 wt. % SiC for a total weight of the body. In another non-limiting embodiment, the body may comprise no greater than 99.99 wt. % SiC for a total weight of the body, such as not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % SiC for a total weight of the body. It will be appreciated that the SiC content of the body can be within a range including any of the minimum and maximum values noted above, including, for example, but not limited to, within a range of at least 90 wt. % and no greater than 99.5 wt. %, such as within a range of at least 95 wt. % and not greater than 99.99 wt. %.

In an embodiment, the first phase can comprise a particular content of SiC that may facilitate improved manufacturing and/or performance of the article. For example, in one embodiment, the first phase can include at least 90 wt. % SiC for a total weight of the first phase, such as at least 91 wt. % or at least 92 wt. % or at least 93 wt. % or at least 94 wt. % or at least 95 wt. %, or at least 96 wt. %, or at least 97 wt. %, or at least 98 wt. % SiC for a total weight of the first phase. In another non-limiting embodiment, the body may comprise no greater than 99.99 wt. % SiC for a total weight of the first phase, such as not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % SiC for a total weight of the first phase. It will be appreciated that the SiC content of the first phase can be within a range including any of the minimum and maximum values noted above, including, for example, but not limited to, within a range of at least 90 wt. % and no greater than 99.5 wt. %, such as within a range of at least 95 wt. % and not greater than 99.99 wt. %.

In an embodiment, the first phase can comprise a majority of the body, such as at least 60% or at least 70% or at least 80% or at least 90% or essentially all of the body can be comprised of the first phase.

In certain non-limiting instances, the body may comprise a particular content of alpha phase SiC that may facilitate improved manufacturing and/or performance of the article. In an embodiment, a majority of the silicon carbide in the body can be alpha phase silicon carbide, or at least 60 wt. % of all silicon carbide in the body can be alpha phase silicon carbide, or at least 62 wt. %, or at least 64 wt. %, or at least 66 wt. %, or at least 68 wt. %, or at least 70 wt. %, or at least 72 wt. %, or at least 74 wt. %, or at least 76 wt. %, or at least 78 wt. %, or at least 80 wt. %, or at least 82 wt. %, or at least 84 wt. %, or at least 86 wt. %, or at least 88 wt. %, or at least 90 wt. %, or at least 92 wt. %, or at least 94 wt. %, or at least 96 wt. %, or at least 98 wt. % alpha phase silicon carbide, or essentially all of the silicon carbide in the body can be alpha phase silicon carbide. In an embodiment no greater than 99.99 wt. % of the silicon carbide in the body can be alpha phase silicon carbide, or not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % of the silicon carbide is alpha phase silicon carbide. It will be appreciated that the alpha phase SiC content can be between any of the minimum and maximum values noted above, including, for example, but not limited to, within a range of at least 90 wt. % and no greater than 99.5 wt. %, or within a range of at least 95 wt. % and not greater than 99.99 wt. %.

In certain non-limiting instances, the first phase may comprise a particular content of alpha phase SiC that may facilitate improved manufacturing and/or performance of the article. In an embodiment, a majority of the silicon carbide in the first phase can be alpha phase silicon carbide, or at least 60 wt. % of all silicon carbide in the first phase can be alpha phase silicon carbide, or at least 62 wt. %, or at least 64 wt. %, or at least 66 wt. %, or at least 68 wt. %, or at least 70 wt. %, or at least 72 wt. %, or at least 74 wt. %, or at least 76 wt. %, or at least 78 wt. %, or at least 80 wt. %, or at least 82 wt. %, or at least 84 wt. %, or at least 86 wt. %, or at least 88 wt. %, or at least 90 wt. %, or at least 92 wt. %, or at least 94 wt. %, or at least 96 wt. %, or at least 98 wt. % alpha phase silicon carbide, or essentially all of the silicon carbide in the first phase can be alpha phase silicon carbide. In an embodiment no greater than 99.99 wt. % of the silicon carbide in the first phase can be alpha phase silicon carbide, or not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % of the silicon carbide is alpha phase silicon carbide. It will be appreciated that the alpha phase SiC content can be between any of the minimum and maximum values noted above, including, for example, but not limited to, within a range of at least 90 wt. % and no greater than 99.5 wt. %, or within a range of at least 95 wt. % and not greater than 99.99 wt. %.

In an embodiment, the silicon carbide in the body can have a particular aspect ratio that may facilitate improved manufacturing and/or performance of the article. In an embodiment, a majority of the silicon carbide in the body can have an aspect ratio (1:w) as viewed in cross-section of not greater than 3:1, or not greater than 2.5:1, or not greater than 2.3:1, or not greater than 2.1:1, or not greater than 2:1, or not greater than 1.9:1, or not greater than 1.8:1, or not greater than 1.7:1, or not greater than 1.6:1, or not greater than 1.5:1, or not greater than 1.4:1, or not greater than 1.3:1, or not greater than 1.2:1. In some instances, the majority of the silicon carbide, such as at least 60% or at least 70% or at least 80% or at least 90% or essentially all of the silicon carbide of the body can have an aspect ratio according to the embodiments noted above. In a particular embodiment, the silicon carbide in the body may be essentially equiaxed, such that the aspect ratio is between 0.9:1 and 1.1:1. It will be appreciated that the aspect ratio can be an average value obtained from evaluation of the microstructure in cross-section using suitable techniques (e.g., SEM) taken from a statistically suitable sample size.

In an embodiment, the body can include SiC of a particular average crystal size that may facilitate improved manufacturing and/or performance of the article. In an embodiment, the body can comprise SiC having an average crystal size of at least 1 micron, or at least 1.5 microns, or at least 2 microns, or at least 2.5 microns, or at least 3 microns, or at least 3.5 microns, or at least 4 microns. In an embodiment, the body can comprise having an average crystal size of no greater than 15 microns, or no greater than 14 microns, or no greater than 13 microns, or no greater than 12 microns, or no greater than 11 microns, or no greater than 10 microns. It will be appreciated that the average crystal size of the SiC may be between any of the minimum and maximum values noted above, including, for example, but not limited to at least 1 micron and not greater than 15 microns, or at least 3 microns and not greater than 12 microns. It will be understood that the average crystal size can be obtained from evaluation of the microstructure in cross-section using suitable techniques (e.g., SEM) taken from a statistically suitable sample size. In certain embodiments, the average crystal size can be evaluated using the uncorrected intercept method based on cross-sectional SEM images as known to those of skill in the art.

In an embodiment, the body can comprise a particular content of boron-containing material that may facilitate improved manufacturing and/or performance of the article. In an embodiment, the body can comprise at least 0.1 wt. % boron-containing material for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body. In another non-limiting embodiment, the body may comprise not greater than 5 wt. % boron-containing material for a total weight of the body, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. % boron containing material for a total weight of the body. It will be appreciated that the content of boron-containing material can be within a range including any of the minimum and maximum values noted above, including for example, but not limited to, within a range of at least 1.0 wt. % and no greater than 5 wt. %, such as within a range of at least 1.1 wt. % and not greater than 3.2 wt. %.

In an embodiment, the body can include boron containing material that includes boron and at least one material from the group of silicon, carbon, or any combination thereof. In an embodiment, the boron-containing material can include boron carbide. In an embodiment, the boron containing material can consist essentially of boron carbide. In an embodiment, the boron containing material can consist of boron carbide and no other boron-containing or carbide-containing species.

In an embodiment, the body can comprise a particular content of oxygen-containing material that may facilitate improved manufacturing and/or performance of the article. In an embodiment, the body can comprise at least 0.1 wt. % oxygen-containing material for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body. In another non-limiting embodiment, the body may comprise not greater than 5 wt. % oxygen-containing material for a total weight of the body, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. % oxygen-containing material for a total weight of the body. It will be appreciated that the content of oxygen-containing material can be within a range including any of the minimum and maximum values noted above, including for example, but not limited to, within a range of at least 0.1 wt. % and no greater than 5 wt. %, such as within a range of at least 0.2 wt. % and not greater than 3.2 wt. %.

In an embodiment, the body can comprise a particular content of aluminum-containing material that may facilitate improved manufacturing and/or performance of the article. In an embodiment, the body can comprise at least 0.01 wt. % aluminum-containing material for a total weight of the body, or at least 0.02 wt. %, or at least 0.03 wt. %, or at least 0.04 wt. %, or at least 0.05 wt. %, or at least 0.06 wt. %, or at least 0.07 wt. %, or at least 0.08 wt. %, or at least 0.09 wt. %, or at least 0.1 wt. % for a total weight of the body. In an embodiment, the body can comprise not greater than 0.1 wt. % aluminum-containing material for a total weight of the body, or not greater than 0.09 wt. %, or not greater than 0.08 wt. %, or not greater than 0.07 wt. %, or not greater than 0.06 wt. %, or not greater than 0.05 wt. %, or not greater than 0.04 wt. %, or not greater than 0.03 wt. %, or not greater than 0.02 wt. %, or not greater than 0.01 wt. % aluminum-containing material for a total weight of the body. It will be appreciated that the content of aluminum-containing material can be within a range including any of the minimum and maximum values noted above, including for example, but not limited to, within a range of at least 0.01 wt. % and no greater than 0.1 wt. %, such as within a range of at least 0.02 wt. % and not greater than 0.09 wt. %.

In an embodiment, the body can comprise a particular content of free carbon that may facilitate improved manufacturing and/or performance of the article. In an embodiment, the body can comprise at least 0.1 wt. % free carbon for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body. In an embodiment, the body can comprise not greater than 5 wt. % free carbon for a total weight of the body, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. % free carbon for a total weight of the body. It will be appreciated that the content of free carbon can be between any of the minimum and maximum values noted above, including, for example, but not limited to, at least 0.1 wt. % and no greater than 5 wt. %, or at least 0.2 wt. % and not greater than 3.2 wt. %.

In an embodiment, the body can comprise a particular content of free metals that may facilitate improved manufacturing and/or performance of the article. In an embodiment, the body can comprise at least 0.01 wt. % free metals for a total weight of the body, or at least 0.02 wt. %, or at least 0.03 wt. %, or at least 0.04 wt. %, or at least 0.05 wt. %, or at least 0.06 wt. %, or at least 0.07 wt. %, or at least 0.08 wt. %, or at least 0.09 wt. %, or at least 0.1 wt. % for a total weight of the body. In an embodiment, the body can comprise not greater than 0.1 wt. % free metals for a total weight of the body, or not greater than 0.09 wt. %, or not greater than 0.08 wt. %, or not greater than 0.07 wt. %, or not greater than 0.06 wt. %, or not greater than 0.05 wt. %, or not greater than 0.04 wt. %, or not greater than 0.03 wt. %, or not greater than 0.02 wt. %, or not greater than 0.01 wt. % free metals for a total weight of the body. It will be appreciated that the content of free metals can be between any of the minimum and maximum values noted above, including, for example, but not limited to, at least 0.01 wt. % and no greater than 0.1 wt. %, or at least 0.02 wt. % and not greater than 0.09 wt. %.

In an embodiment, the body can include trace amounts of calcium, iron, titanium, vanadium, or a combination thereof. In an embodiment, the body can include trace amounts of calcium, iron, titanium, and vanadium. Trace amounts shall be interpreted to mean an amount of less than 100 ppm but greater than 0 ppm.

In an embodiment, the body can include pores having a particular median pore size, D50p, that may facilitate improved manufacturing and/or performance of the article. Pore sizes can be measured using X-Ray tomography with 3 μm/voxel resolution on sample having dimensions 3×3×4 mm³. In an embodiment, the pores may have a D50p of at least 10 microns, or at least 12 microns, or at least 14 microns, or at least 16 microns, or at least 18 microns, or at least 20 microns, or at least 22 microns, or at least 24 microns, or at least 26 microns, or at least 28 microns, or at least 30 microns, or at least 32 microns, or at least 34 microns, or at least 36 microns, or at least 38 microns, or at least 40 microns, or at least 42 microns, or at least 44 microns, or at least 46 microns, or at least 48 microns. In another embodiment, the pores may have a D50p of no greater than 100 microns, or no greater than 95 microns, or no greater than 90 microns, or no greater than 85 microns, or no greater than 80 microns, or no greater than 75 microns, or no greater than 70 microns, or no greater than 65 microns, or no greater than 62 microns, or no greater than 61 microns, or no greater than 60 microns, or no greater than 59 microns, or no greater than 58 microns, or no greater than 57 microns, or no great than 56 microns, or no greater than 55 microns, or no greater than 54 microns, or no greater than 53 microns, or no greater than 52 microns, or no greater than 51 microns. It will be appreciated that the D50p may be between any of the minimum and maximum values noted above, including, for example, at least 10 microns and no greater than 60 microns, or at least 12 microns and no greater than 80 microns, or at least 51 microns and no greater than 100 microns.

In an embodiment, the body can include pores having a particular pore spacing distance distribution that may facilitate improved manufacturing and/or performance of the article. Pore spacing can be determined by imaging an article in 3D with a resolution of 3 μm/voxel using an X-ray computed-tomography scanner (VTomeX from GE). The pore detection can be based on a grey level segmentation. Neighboring pores can be identified using Delaunay triangulation (See Golias, N. A., & Dutton, R. W. (1997). Delaunay triangulation and 3D adaptive mesh generation. Finite elements in analysis and design, 25(3-4), 331-341.) The distance between neighboring pores can be measured using image analysis software and the distribution can be plotted.

In an embodiment, the body can have a mean pore spacing distance that may facilitate improved manufacturing and/or performance of the article. In an embodiment, the mean pore spacing distance may be, at least 205 microns, or at least 206 microns, or at least 207 microns, or at least 208 microns, or at least 209 microns, or at least 210 microns, or at least 211 microns, or at least 212 microns, or at least 213 microns, or at least 214 microns, or at least 215 microns, or at least 216 microns, or at least 217 microns, or at least 218 microns, or at least 219 microns, or at least 220 microns, or at least 221 microns, or at least 222 microns, or at least 223 microns, or at least 224 microns, or at least 225 microns. In an embodiment, the mean pore spacing distance may be not greater than 300 microns, or not greater than 295 microns, or not greater than 290

microns, or not greater than 285 microns, or not greater than 280 microns, or not greater than 275 microns, or not greater than 270 microns, or not greater than 265 microns, or not greater than 260 microns. It will be appreciated that the mean pore spacing may be between any of the minimum and maximum values noted above, including, for example, at least 206 microns and no greater than 260 microns, or at least 206 microns and no greater than 300 microns, or at least 225 microns and no greater than 260 microns.

In an embodiment, the body can have a pore spacing distance standard deviation that may facilitate improved manufacturing and/or performance of the article. The standard deviation can be calculated from a pore spacing distribution obtained from the methods disclosed in this application. In an embodiment, the pore spacing distance standard deviation can be not greater than 90, or not greater than 89, or not greater than 88, or not greater than 87, or not greater than 86, or not greater than 85, or not greater than 84, or not greater than 83, or not greater than 82, or not greater than 81, or not greater than 80, or not greater than 79, or not greater than 78, or not greater than 77, or not greater than 76, or not greater than 75. In an embodiment, the pore spacing distance standard deviation can be at least 60, or at least 61, or at least 62, or at least 63, or at least 64, or at least 65, or at least 66, or at least 67, or at least 68, or at least 69, or at least 70, or at least 71, or at least 72. It will be appreciated that the pore spacing standard deviation may be between any of the minimum and maximum values noted above, including, for example, at least 90 and no greater than 60, or at least 65 and no greater than 85, or at least 67 microns and no greater than 70.

In an embodiment, the body can have a median pore spacing distance, D50d, which may facilitate improved manufacturing and/or performance of the article. In an embodiment, D50d may be at least 190 microns, or at least 191 microns, or at least 192 microns, or at least 193 microns, or at least 194 microns, or at least 195 microns, or at least 196 microns, or at least 197 microns, or at least 198 microns, or at least 199 microns, or at least 200 microns, or at least 201 microns, or at least 202 microns, or at least 203 microns, or at least 204 microns, or at least 205 microns, or at least 206 microns, or at least 207 microns, or at least 208 microns, or at least 209 microns, or at least 210 microns, or at least 211 microns, or at least 212 microns, or at least 213 microns, or at least 214 microns, or at least 215 microns, or at least 216 microns, or at least 217 microns, or at least 218 microns, or at least 219 microns, or at least 220 microns. In an embodiment, D50d can be not greater than 500 microns, or not greater than 450 microns, or not greater than 300 microns, or not greater than 295 microns, or not greater than 290 microns, or not greater than 285 microns, or not greater than 280 microns, or not greater than 275 microns, or not greater than 270 microns, or not greater than 265 microns, or not greater than 260 microns, or not greater than 255 microns, or not greater than 250 microns. It will be appreciated that D50d may be between any of the minimum and maximum values noted above, including, for example, at least 190 and no greater than 260 microns, or at least 200 microns and no greater than 255 microns, or at least 220 microns and no greater than 250 microns.

In an embodiment, the body can have a D25d which may facilitate improved manufacturing and/or performance of the article. D25d is the 25^{th} percentile of a pore spacing distribution obtained according to the methods disclosed in this application. 25% of the pore spacings are below the D25d, and 75% are above. In an embodiment, D25d may be at least 150 microns, or at least 151 microns, or at least 152 microns, or at least 153 microns, or at least 154 microns, or at least 155 microns, or at least 156 microns, or at least 157 microns, or at least 158 microns, or at least 159 microns, or at least 160 microns, or at least 161 microns, or at least 162 microns, or at least 163 microns, or at least 164 microns, or at least 165 microns. In an embodiment, D25d can be not greater than 300 microns, or not greater than 290 microns, or not greater than 280 microns, or not greater than 270 microns, or not greater than 260 microns, or not greater than 250 microns, or not greater than 240 microns, or not greater than 230 microns, or not greater than 220 microns, or not greater than 210 microns, or not greater than 200 microns. It will be appreciated that D25d may be between any of the minimum and maximum values noted above, including, for example, at least 150 and no greater than 260 microns, or at least 155 microns and no greater than 250 microns, or at least 160 microns and no greater than 230 microns.

In an embodiment, the body can have a D10d which may facilitate improved manufacturing and/or performance of the article. D10d is the 10^{th} percentile of a pore spacing distribution obtained according to the methods disclosed in this application. 10% of the pore spacings are below the D10d, and 90% are above. In an embodiment, D10d may be at least 110 microns, or at least 111 microns, or at least 112 microns, or at least 113 microns, or at least 114 microns, or at least 115 microns. In an embodiment, D10d can be not greater than 200 microns, or not greater than 190 microns, or not greater than 180 microns, or not greater than 170 microns, or not greater than 160 microns, or not greater than 150 microns, or not greater than 140 microns, or not greater than 130 microns. It will be appreciated that D10d may be between any of the minimum and maximum values noted above, including, for example, at least 110 and no greater than 190 microns, or at least 113 microns and no greater than 150 microns, or at least 115 microns and no greater than 130 microns.

In an embodiment, the body can have a D5d which may facilitate improved manufacturing and/or performance of the article. D5d is the 5^{th} percentile of a pore spacing distribution obtained according to the methods disclosed in this application. 5% of the pore spacings are below the D5d, and 95% are above. In an embodiment, D5d may be at least 90 microns, or at least 91 microns, or at least 92 microns, or at least 93 microns, or at least 94 microns, or at least 95 microns. In an embodiment, D5d can be not greater than 150 microns, or not greater than 145 microns, or not greater than 140 microns, or not greater than 135 microns, or not greater than 130 microns, or not greater than 125 microns, or not greater than 120 microns. It will be appreciated that D5d may be between any of the minimum and maximum values noted above, including, for example, at least 90 and no greater than 150 microns, or at least 93 microns and no greater than 130 microns, or at least 95 microns and no greater than 120 microns.

In an embodiment, the body can have a D75d which may facilitate improved manufacturing and/or performance of the article. D75d is the 75^{th} percentile of a pore spacing distribution obtained according to the methods disclosed in this application. 75% of the pore spacings are below the D75d, and 25% are above. In an embodiment, D75d may be at least 235 microns, or at least 240 microns, or at least 245 microns, or at least 250 microns, or at least 255 microns, or at least 260 microns, or at least 265 microns. In an embodiment, D75d can be not greater than 500 microns, or not greater than 480 microns, or not greater than 460 microns, or not greater than 440 microns, or not greater than 420 microns, or not greater than 400 microns, or not greater than 380 microns, or not greater than 360 microns, or not greater than 340 microns, or not greater than 330 microns, or not greater than 320 microns, or not greater than 310 microns, or not greater than 300 microns, or not greater than 295 microns, or not greater than 290 microns, or not greater than 285 microns, or not greater than 280 microns. It will be appreciated that D75d may be between any of the minimum and maximum values noted above, including, for example, at least 235 and no greater than 500 microns, or at least 240 microns and no greater than 400 microns, or at least 265 microns and no greater than 280 microns.

In an embodiment, the body can have a D90d which may facilitate improved manufacturing and/or performance of the article. D90d is the 90^{th} percentile of a pore spacing distribution obtained according to the methods disclosed in this application. 90% of the pore spacings are below the D90d, and 10% are above. In an embodiment, D90d may be at least 270 microns, or at least 275 microns, or at least 280 microns, or at least 285 microns, or at least 290 microns, or at least 295 microns, or at least 300 microns, or at least 305 microns. In an embodiment, D90d can be not greater than 600 microns, or not greater than 550 microns, or not greater than 500 microns, or not greater than 450 microns, or not greater than 400 microns, or not greater than 380 microns, or not greater than 360 microns, or not greater than 350 microns, or not greater than 345 microns, or not greater than 340 microns, or not greater than 335 microns, or not greater than 330 microns, or not greater than 325 microns. It will be appreciated that D90d may be between any of the minimum and maximum values noted above, including, for example, at least 270 and no greater than 500 microns, or at least 280 microns and no greater than 400 microns, or at least 305 microns and no greater than 325 microns.

In an embodiment, the body can have a D95d which may facilitate improved manufacturing and/or performance of the article. D95d is the 95^{th} percentile of a pore spacing distribution obtained according to the methods disclosed in this application. 95% of the pore spacings are below the D95, and 5% are above. In an embodiment, D95d may be at least 290 microns, or at least 295 microns, or at least 300 microns, or at least 305 microns, or at least 310 microns, or at least 315 microns, or at least 320 microns, or at least 325 microns, or at least 330 microns, or at least 335 microns. In an embodiment, D95d can be not greater than 600 microns, or not greater than 550 microns, or not greater than 500 microns, or not greater than 450 microns, or not greater than 400 microns, or not greater than 380 microns, or not greater than 375 microns, or not greater than 370 microns, or not greater than 365 microns, or not greater than 360 microns, or not greater than 355 microns, or not greater than 350 microns. It will be appreciated that D95d may be between any of the minimum and maximum values noted above, including for example, but not limited to, at least 290 and no greater than 500 microns, or at least 300 microns and no greater than 400 microns, or at least 310 microns and no greater than 350 microns.

In an embodiment, the body can have a particular ratio of mean pore spacing to d50p

$$( \frac{mean pore spacing}{D 50 p} )$$

that may facilitate improved manufacturing and/or performance of the article.

In an embodiment,

$$\frac{mean pore spacing}{D 50 p}$$

can be at least 1.0, or at least 1.1, or at least 1.2, or at least 1.3, or at least 1.4, or at least 1.5, or at least 1.6, or at least 1.7, or at least 1.8, or at least 1.9, or at least 2.0, or at least 2.1, or at least 2.2, or at least 2.3, or at least 2.4, or at least 2.5, or at least 2.6, or at least 2.7, or at least 2.8, or at least 2.9, or at least 3.0, or at least 3.1, or at least 3.2, or at least 3.3, or at least 3.4, or at least 3.5, or at least 3.6, or at least 3.7, or at least 3.8, or at least 3.9, or at least 4.0 or at least 4.1, or at least 4.2, or at least 4.3, or at least 4.4, or at least 4.5, or at least 4.6. In an embodiment,

$$\frac{mean pore spacing}{D 50 p}$$

can be not greater than 10, or not greater than 9, or not greater than 8, or not greater than 7, or not greater than 6, or not greater than 5. I will be appreciated that

$$\frac{mean pore spacing}{D 50 p}$$

can be between any of the minimum and maximum values noted above, including, for example, but not limited to, at least 1.0 and not greater than 10, at least 2.0 and not greater than 9, or at least 2.5 and not greater than 5.

In an embodiment, the body can have a particular ratio of D50d to D50p

$$( \frac{D 50 d}{D 50 p} )$$

that may facilitate improved manufacturing and/or performance of the article. In an embodiment,

$$\frac{D 50 d}{D 50 p}$$

can be at least 1.0, or at least 1.1, or at least 1.2, or at least 1.3, or at least 1.4, or at least 1.5, or at least 1.6, or at least 1.7, or at least 1.8, or at least 1.9, or at least 2.0, or at least 2.1, or at least 2.2, or at least 2.3, or at least 2.4, or at least 2.5, or at least 2.6, or at least 2.7, or at least 2.8, or at least 2.9, or at least 3.0, or at least 3.1, or at least 3.2, or at least 3.3, or at least 3.4, or at least 3.5, or at least 3.6, or at least 3.7, or at least 3.8, or at least 3.9, or at least 4.0 or at least 4.1, or at least 4.2, or at least 4.3, or at least 4.4. In an embodiment, the

$$\frac{D 50 d}{D 50 p}$$

can be not greater than 10, or not greater than 9, or not greater than 8, or not greater than 7, or not greater than 6, or not greater than 5. It will be appreciated than

$$\frac{D 50 d}{D 50 p}$$

can be between any of the minimum and maximum values noted above, including, for example, but not limited to, at least 1.0 and not greater than 10, at least 2.0 and not greater than 9, or at least 2.5 and not greater than 5.

In an embodiment, the body can have a particular volume of porosity for a total volume of the body that may facilitate improved manufacturing and/or performance of the article. In an embodiment, the body can include at least 0.5 vol % pores for a total volume of the body, or at least 0.6 vol %, or at least 0.7 vol %, or at least 0.8 vol %, or at least 0.9 vol %, or at least 1.0 vol % vol %, or at least 1.1 vol %, or at least 1.2 vol %, or at least 1.3 vol %, or at least 1.4 vol %, or at least 1.5 vol %, or at least 1.6 vol %, or at least 1.7 vol %, or at least 1.8 vol %, or at least 1.9 vol %, 2.0 vol %, or at least 2.1 vol %, or at least 2.2 vol %, or at least 2.3 vol %, or at least 2.4 vol %, or at least 2.5 .vol %, or at least 2.6 vol %, or at least 2.7 vol %, or at least 2.8 vol %, or at least 2.9 vol %, or at least 3.0 vol % of the volume of the body. In an embodiment, the pores can comprise no greater than 5 vol % of the volume of the body, or not greater than 4.8 vol %, or not greater than 4.6 vol %, or not greater than 4.4 vol %, or not greater than 4.2 vol %, or not greater than 4.0 vol %, or not greater than 3.8 vol %, or not greater than 3.74 vol %, or not greater than 3.6 vol %, or not greater than 3.4 vol %, or not greater than 3.2 vol %, or not greater than 3.0 vol % of the volume of the body. It will be appreciated that the volume of pores may be between any of the minimum and maximum values noted above, including, for example, but not limited to within a range of at least 0.6 vol % and or not greater than 4.4 vol % or within a range of at least 2.5 vol % and not greater than 3.74 vol %.

In an embodiment, the body can include a particular amount of closed porosity that may facilitate improved manufacturing and/or performance of the article. In an embodiment at least 50% of all porosity is closed porosity or at least 60%, or at least 70%, or at least 80%, or at least 90%, or at least 95%, or at least 97%, or essentially all of the porosity in the body is closed porosity.

In an embodiment, the body can have a particular density that may facilitate improved manufacturing and/or performance of the article. In an embodiment, the body can have a density of at least 2.00 g/cm³, or at least 2.05 g/cm³, or at least 2.10 g/cm³, or at least 2.15 g/cm³, or at least 2.20 g/cm³, or at least 2.25 g/cm³, or at least 2.30 g/cm³, or at least 2.35 g/cm³, or at least 2.40 g/cm³, or at least 2.45 g/cm³, or at least 2.50 g/cm³, or at least 2.55 g/cm³, or at least 2.60 g/cm³, or at least 2.65 g/cm³, or at least 2.70 g/cm³, or at least 2.75 g/cm³, or at least 2.80 g/cm³, or at least 2.85 g/cm³, or at least 2.90 g/cm³, or at least 2.95 g/cm³, or at least 3.0 g/cm³, or at least 3.01 g/cm³, or at least 3.02 g/cm³, or at least 3.03 g/cm³, or at least 3.04 g/cm³, or at least 3.05 g/cm³, or at least 3.06 g/cm³, or at least 3.07 g/cm³, or at least 3.08 g/cm³, or at least 3.09 g/cm³. In an embodiment, the body can have a density of no greater than 4.00 g/cm³, or no greater than 3.95 g/cm³, or no greater than 3.90 g/cm³, or no greater than 3.85 g/cm³, or no greater than 3.80 g/cm³, or no greater than 3.75 g/cm³, or no greater than 3.70 g/cm³, or no greater than 3.65 g/cm³, or no greater than 3.60 g/cm³, or no greater than 3.55 g/cm³, or no greater than 3.50 g/cm³, or no greater than 3.45 g/cm³, or no greater than 3.40 g/cm³, or no greater than 3.35 g/cm³, or no greater than 3.30 g/cm³, or no greater than 3.25 g/cm³, or no greater than 3.20 g/cm³ or no greater than 3.19 g/cm³, or no greater than 3.18 g/cm³, or no greater than 3.17 g/cm³, or no greater than 3.16 g/cm³, or no greater than 3.15 g/cm³, or no greater than 3.14 g/cm³, or no greater than 3.13 g/cm³. It will be appreciated that the density of the body may be between any of the minimum and maximum values noted above, including, for example, but not limited to within a range of at least 2.00 g/cm³ and no greater than 4.00 g/cm³, or within a range of at least 3.09 g/cm³ and no greater than 3.13 g/cm³.

In an embodiment, the body can have a particular hardness that may facilitate improved manufacturing and/or performance of the article. In an embodiment, the body can have a hardness of at least 2000 Knoop, or at least 2100 Knoop, or at least 2200 Knoop, or at least 2300 Knoop, or at least 2400 Knoop, or at least 2500 Knoop, or at least 2600 Knoop, or at least 2700 Knoop. In an embodiment, the body can have a hardness of no greater than 3500 Knoop, or not greater than 3400 Knoop, or not greater than 3300 Knoop, or not greater than 3200 Knoop, or not greater than 3100 Knoop, or not greater than 3000 Knoop, or not greater than 2900 Knoop. It will be appreciated that the hardness of the body may be between any of the minimum and maximum values noted above, including, for example, but not limited to at least 2000 Knoop and no greater than 3500 Knoop, or at least 2200 Knoop and no greater than 3300 Knoop.

In an embodiment, the body can have a particular fracture toughness that may facilitate improved manufacturing and/or performance of the article. In an embodiment, the body can have a fracture toughness of at least 3.0 MPa m^{1/2}, or at least 3.1 MPa m^{1/2}, or at least 3.2 MPa m^{1/2}, or at least 3.3 MPa m^{1/2}, or at least 3.4 MPa m^{1/2}, or at least 3.5 MPa m^{1/2}, or at least 3.6 MPa m^{1/2}, or at least 3.7 MPa m^{1/2}, or at least 3.8 MPa m^{1/2}, or at least 3.9 MPa m^{1/2}, or at least 4.0 MPa m^{1/2}. In an embodiment, the body can have a fracture toughness of no greater than 5.0 MPa m^{1/2}, or no greater than 4.9 MPa m^{1/2}, or no greater than 4.8 MPa m^{1/2}, or no greater than 4.7 MPa m^{1/2}, or no greater than 4.6 MPa m^{1/2}, or no greater than 4.5 MPa m^{1/2}. It will be appreciated that the fracture toughness of the body may be between any of the minimum and maximum values noted above, including, for example, but not limited to at least 3.0 MPa m^{1/2} and no greater than 4.9 MPa m^{1/2}, or at least 3.4 MPa m^{1/2} and no greater than 4.8 MPa m^{1/2}.

In an embodiment, the body can have a particular 4 pt flexural strength that may facilitate improved manufacturing and/or performance of the article. In an embodiment, the body can have a 4 pt flexural strength of at least 100 MPa, or at least 110 MPa, or at least 120 MPa, or at least 130 MPa, or at least 140 MPa, or at least 150 MPa, or at least 160 MPa, or at least 170 MPa, or at least 180 MPa, or at least 190 MPa, or at least 200 MPa, or at least 210 MPa, or at least 220 MPa. In an embodiment, the body can have a 4 pt flexural strength of no greater than 400 MPa, or no greater than 380 MPa, or no greater than 360 MPa, or no greater than 340 MPa, or no greater than 320 MPa, or no greater than 300 MPa, or no greater than 280 MPa, or no greater than 260 MPa. It will be appreciated that the 4 pt flexural strength of the body may be between any of the minimum and maximum values noted above, including, for example, but not limited to at least 100 MPa no greater than 400 MPa, or at least 120 MPa and no greater than 300 MPa.

In an embodiment, the body can have a particular MOE that may facilitate improved manufacturing and/or performance of the article. In an embodiment, the body can have an MOE of at least 100 GPa, or at least 125 GPa, or at least 150 GPa, or at least 175 GPa, or at least 200 GPa, or at least 225 GPa, or at least 250 GPa, or at least 275 GPa, or at least 300 GPa, at least 325 GPa, or at least 350 GPa. In an embodiment, the body can have an MOE of no greater than 700 GPa, or no greater than 675 GPa, or no greater than 650 GPa, or no greater than 625 GPa, or no greater than 600 GPa, or no greater than 575 GPa, or no greater than 550 GPa, or no greater than 525 GPa, or no greater than 500 GPa, or no greater than 475 GPa, or no greater than 450 GPa. It will be appreciated that the MOE of the body may be between any of the minimum and maximum values noted above, including, for example, but not limited to at least 100 GPa and no greater than 450 GPa, or at least 150 GPa and no greater than 550 GPa.

In an embodiment, the article may have a particular use in armor applications. For example, an article can be an armor component that can include a layer comprising the body described herein. The armor component can include a ballistic armor insert.

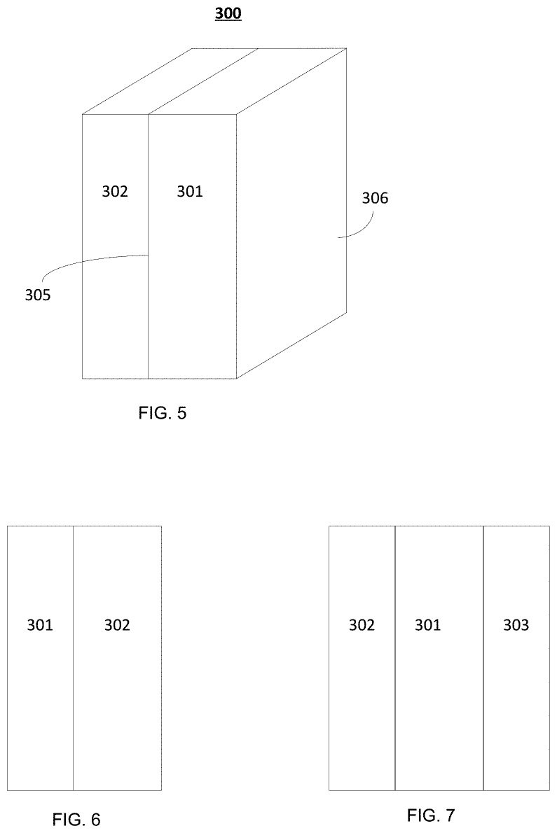

In accordance with an embodiment, an armor component can include the body and a first component adjacent the body. FIG. 5 includes a perspective view illustration of an armor component 300 in accordance with an embodiment. As illustrated, the armor component 300 includes a body 301 and a first component 302. In particular instances, the first component 302 may overlie the body 301. In other embodiments, it will be appreciated that the first component 302 may have a particular position relative to the body 301. For example, as illustrated in FIG. 6, the first component 302 may underlie the body 301. As further illustrated in FIG. 7, another construction of the armor component 300 can include the body 301 disposed between the first component 302 and a second component 303. It will be appreciated that various suitable arrangements of the body 301 relative to other components (e.g., the first component 302 and the second component 303) are contemplated and within the scope of the embodiments described herein. Referring to FIG. 5, in accordance with an embodiment, the first component 302 can be abutting at least a portion of the body 301, and more particularly, may be in direct contact with a first major surface 305 of the body 301. More particularly, the first component 302 and body 301 may be bonded to each other at the first major surface 305 of the body 301. In an embodiment, a face of the body may be a strike face 306 of the armor. In an alternative embodiment, the body does not comprise any faces that serve as a strike face of the armor. It will be appreciated that an armor component, according to embodiments, may have more than 3 layers or components, or any number of layers or components.

In one embodiment, the body may have a remarkable ballistic capability compared to conventional products. According to one aspect, the body may have a ballistic limit velocity V₅₀ of at least 766 m/s, such as at least 767 m/s, or at least 768 m/s, or at least 769 m/s, or at least 770 m/s, or at least 771 m/s, or at least 772 m/s, or at least 773 m/s, or at least 774 m/s, or at least 775 m/s, or at least 776 m/s, or at least 777 m/s, or at least 778 m/s, or at least m/s, or at least 779 m/s, or at least 780 m/s, or at least 781 m/s, or at least 782 m/s, or at least 783 m/s, or at least 784 m/s, or at least 785 m/s. In an embodiment, the body can have a ballistic limit velocity V₅₀ of not greater than 900 m/s, or not greater than 875 m/s, or not greater than 850 m/s, or not greater than 840 m/s, or not greater than 830 m/s, or not greater than 820 m/s, or not greater than 815 m/s, or not greater than 810 m/s, or not greater than 805 m/s, or not greater than 800 m/s. It will be appreciated that the ballistic limit velocity V₅₀ of the body may be between any of the minimum and maximum values noted above, including, for example, but not limited to at least 766 m/s and no greater than 900 m/s, or at least 771 m/s and no greater than 840 m/s. A method for determining V₅₀ is detailed in the examples.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. An article comprising:

a body including:

a first phase comprising alpha silicon carbide; and

pores contained in the body, the pores having a mean spacing distance of at least 205 microns and not greater than 300.

Embodiment 2. An article comprising:

a body including:

a first phase comprising alpha silicon carbide; and

pores contained in the body defining at least 0.5 vol % and not greater than 4 vol % porosity, and wherein pores have at least one of:

a mean spacing distance of at least 205 microns and not greater than 300;

a ballistic limit velocity V50 of at least 766 m/s;

or a combination of a) and b).

Embodiment 3. An article comprising:

a body including:

a first phase comprising alpha silicon carbide; and

a ballistic limit velocity V50 of at least 766 m/s.

Embodiment 4. The article of embodiment 3, wherein the body comprises pores contained within the body.

Embodiment 5. An article comprising:

a body including:

a first phase comprising alpha silicon carbide; and

pores contained in the body,

wherein the ratio of the median pore spacing to median pore size, (D50d)/D50p, is at least 3.2.

Embodiment 6. The article of any one of embodiments 1, 2, 4, or 5, wherein the pores have a median size, D50p, least 10 microns, or at least 12 microns, or at least 14 microns, or at least 16 microns, or at least 18 microns, or at least 20 microns, or at least 22 microns, or at least 24 microns, or at least 26 microns, or at least 28 microns, or at least 30 microns, or at least 32 microns, or at least 34 microns, or at least 36 microns, or at least 38 microns, or at least 40 microns, or at least 42 microns, or at least 44 microns, or at least 46 microns, or at least 48 microns.

Embodiment 7. The article of any one of embodiments 1, 2, 4, or 5, wherein the pores have a median size, D50p, of no greater than 100 microns, or no greater than 95 microns, or no greater than 90 microns, or no greater than 85 microns, or no greater than 80 microns, or no greater than 75 microns, or no greater than 70 microns, or no greater than 65 microns, or no greater than 62 microns, or no greater than 61 microns, or no greater than 60 microns, or no greater than 59 microns, or no greater than 58 microns, or no greater than 57 microns, or no great than 56 microns, or no greater than 55 microns, or no greater than 54 microns, or no greater than 53 microns, or no greater than 52 microns, or no greater than 51 microns.

Embodiment 8. The article of any one of embodiments 1, 2, 4, or 5, wherein the pores have a mean spacing distance of at least 206 microns, or at least 207 microns, or at least 208 microns, or at least 209 microns, or at least 210 microns, or at least 211 microns, or at least 212 microns, or at least 213 microns, or at least 214 microns, or at least 215 microns, or at least 216 microns, or at least 217 microns, or at least 218 microns, or at least 219 microns, or at least 220 microns, or at least 221 microns, or at least 222 microns, or at least 223 microns, or at least 224 microns, or at least 225 microns.

Embodiment 9. The article of any one of embodiments 1, 2, 4, or 5, wherein the pores have a mean spacing distance of not greater than 300 microns, or not greater than 295 microns, or not greater than 290 microns, or not greater than 285 microns, or not greater than 280 microns, or not greater than 275 microns, or not greater than 270 microns, or not greater than 265 microns, or not greater than 260 microns.

Embodiment 10. The article of any one of embodiments 1, 2, 4, or 5, wherein the pores have a spacing distance standard deviation of not greater than 90, or not greater than 89, or not greater than 88, or not greater than 87, or not greater than 86, or not greater than 85, or not greater than 84, or not greater than 83, or not greater than 82, or not greater than 81, or not greater than 80, or not greater than 79, or not greater than 78, or not greater than 77, or not greater than 76, or not greater than 75.

Embodiment 11. The article of any one of embodiments 1, 2, 4, or 5, wherein the pores have a spacing distance standard deviation of at least 60, or at least 61, or at least 62, or at least 63, or at least 64, or at least 65, or at least 66, or at least 67, or at least 68, or at least 69, or at least 70, or at least 71, or at least 72.

Embodiment 12. The article of any one of embodiments 1, 2, 4, or 5, wherein the median distance between the pores D50d, is at least 190 microns, or at least 191 microns, or at least 192 microns, or at least 193 microns, or at least 194 microns, or at least 195 microns, or at least 196 microns, or at least 197 microns, or at least 198 microns, or at least 199 microns, or at least 200 microns, or at least 201 microns, or at least 202 microns, or at least 203 microns, or at least 204 microns, or at least 205 microns, or at least 206 microns, or at least 207 microns, or at least 208 microns, or at least 209 microns, or at least 210 microns, or at least 211 microns, or at least 212 microns, or at least 213 microns, or at least 214 microns, or at least 215 microns, or at least 216 microns, or at least 217 microns, or at least 218 microns, or at least 219 microns, or at least 220 microns.

Embodiment 13. The article of any one of embodiments 1, 2, 4, or 5, wherein the median distance between the pores D50d is not greater than 500 microns, or not greater than 450 microns, or not greater than 300 microns, or not greater than 295 microns, or not greater than 290 microns, or not greater than 285 microns, or not greater than 280 microns, or not greater than 275 microns, or not greater than 270 microns, or not greater than 265 microns, or not greater than 260 microns, or not greater than 255 microns, or not greater than 250 microns.

Embodiment 14. The article of any one of embodiments 1, 2, 4, or 5, wherein D25d, is at least 150 microns, or at least 151 microns, or at least 152 microns, or at least 153 microns, or at least 154 microns, or at least 155 microns, or at least 156 microns, or at least 157 microns, or at least 158 microns, or at least 159 microns, or at least 160 microns, or at least 161 microns, or at least 162 microns, or at least 163 microns, or at least 164 microns, or at least 165 microns.

Embodiment 15. The article of any one of embodiments 1, 2, 4, or 5, wherein D25d is not greater than 300 microns, or not greater than 290 microns, or not greater than 280 microns, or not greater than 270 microns, or not greater than 260 microns, or not greater than 250 microns, or not greater than 240 microns, or not greater than 230 microns, or not greater than 220 microns, or not greater than 210 microns, or not greater than 200 microns.

Embodiment 16. The article of any one of embodiments 1, 2, 4, or 5, wherein D10d is at least 110 microns, or at least 111 microns, or at least 112 microns, or at least 113 microns, or at least 114 microns, or at least 115 microns.

Embodiment 17. The article of any one of embodiments 1, 2, 4, or 5, wherein D10d is not greater than 200 microns, or not greater than 190 microns, or not greater than 180 microns, or not greater than 170 microns, or not greater than 160 microns, or not greater than 150 microns, or not greater than 140 microns, or not greater than 130 microns.

Embodiment 18. The article of any one of embodiments 1, 2, 4, or 5, wherein D5d, is at least 90 microns, or at least 91 microns, or at least 92 microns, or at least 93 microns, or at least 94 microns, or at least 95 microns.

Embodiment 19. The article of any one of embodiments 1, 2, 4, or 5, wherein D5d is not greater than 150 microns, or not greater than 145 microns, or not greater than 140 microns, or not greater than 135 microns, or not greater than 130 microns, or not greater than 125 microns, or not greater than 120 microns.

Embodiment 20. The article of any one of embodiments 1, 2, 4, or 5, wherein D75d, is at least 235 microns, or at least 240 microns, or at least 245 microns, or at least 250 microns, or at least 255 microns, or at least 260 microns, or at least 265 microns.

Embodiment 21. The article of any one of embodiments 1, 2, 4, or 5, wherein D75d is not greater than 500 microns, or not greater than 480 microns, or not greater than 460 microns, or not greater than 440 microns, or not greater than 420 microns, or not greater than 400 microns, or not greater than 380 microns, or not greater than 360 microns, or not greater than 340 microns, or not greater than 330 microns, or not greater than 320 microns, or not greater than 310 microns, or not greater than 300 microns, or not greater than 295 microns, or not greater than 290 microns, or not greater than 285 microns, or not greater than 280 microns.

Embodiment 22. The article of any one of embodiments 1, 2, 4, or 5, wherein D90d, is at least 270 microns, or at least 275 microns, or at least 280 microns, or at least 285 microns, or at least 290 microns, or at least 295 microns, or at least 300 microns, or at least 305 microns.

Embodiment 23. The article of any one of embodiments 1, 2, 4, or 5, wherein D90d is not greater than 600 microns, or not greater than 550 microns, or not greater than 500 microns, or not greater than 450 microns, or not greater than 400 microns, or not greater than 380 microns, or not greater than 360 microns, or not greater than 350 microns, or not greater than 345 microns, or not greater than 340 microns, or not greater than 335 microns, or not greater than 330 microns, or not greater than 325 microns.

Embodiment 24. The article of any one of embodiments 1, 2, 4, or 5, wherein D95d, is at least 290 microns, or at least 295 microns, or at least 300 microns, or at least 305 microns, or at least 310 microns, or at least 315 microns, or at least 320 microns, or at least 325 microns, or at least 330 microns, or at least 335 microns.

Embodiment 25. The article of any one of embodiments 1, 2, 4, or 5, wherein D95d is not greater than 600 microns, or not greater than 550 microns, or not greater than 500 microns, or not greater than 450 microns, or not greater than 400 microns, or not greater than 380 microns, or not greater than 375 microns, or not greater than 370 microns, or not greater than 365 microns, or not greater than 360 microns, or not greater than 355 microns, or not greater than 350 microns.

Embodiment 26. The article of any one of embodiments 1, 2, 4, or 5, wherein the body comprises at least 90 wt. % SiC for a total weight of the body, or at least 91 wt. %, or at least 92 wt. %, or at least 93 wt. %, or at least 94 wt. %, or at least 95 wt. %, or at least 96 wt. %, or at least 97 wt. %, or at least 98 wt. % SiC for a total weight of the body.

Embodiment 27. The article of any one of embodiments 1, 2, 4, or 5, wherein the body comprises no greater than 99.99 wt. % SiC for a total weight of the body, or not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % SiC for a total weight of the body.

Embodiment 28. The article of any one of embodiments 1, 2, 4, or 5, wherein a majority of the silicon carbide within in the body is alpha phase silicon carbide, or at least 60 wt. % of all silicon carbide in the body is alpha phase silicon carbide, or at least 62 wt. %, or at least 64 wt. %, or at least 66 wt. %, or at least 68 wt. %, or at least 70 wt. %, or at least 72 wt. %, or at least 74 wt. %, or at least 76 wt. %, or at least 78 wt. %, or at least 80 wt. %, or at least 82 wt. %, or at least 84 wt. %, or at least 86 wt. %, or at least 88 wt. %, or at least 90 wt. %, or at least 92 wt. %, or at least 94 wt. %, or at least 96 wt. %, or at least 98 wt. % alpha phase silicon carbide, or essentially all of the silicon carbide in the body is alpha phase silicon carbide.

Embodiment 29. The article of any one of embodiments 1, 2, 4, or 5, wherein the body comprises no greater than 99.99 wt. % of the silicon carbide within the body is alpha phase silicon carbide, or not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % of the silicon carbide is alpha phase silicon carbide.

Embodiment 30. The article of any one of embodiments 1, 2, 4, or 5, wherein a majority of the silicon carbide in the body comprises an aspect ratio (1:w) as viewed in cross-section of not greater than 3:1, or not greater than 2.5:1, or not greater than 2.3:1, or not greater than 2.1:1, or not greater than 2:1, or not greater than 1.9:1, or not greater than 1.8:1, or not greater than 1.7:1, or not greater than 1.6:1, or not greater than 1.5:1, or not greater than 1.4:1, or not greater than 1.3:1, or not greater than 1.2:1.

Embodiment 31. The article of any one of embodiments 1, 2, 4, or 5, wherein the body comprises a boron-containing material in an amount of at least 0.1 wt. % for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body.

Embodiment 32. The article of any one of embodiments 1, 2, 4, or 5, wherein the body comprises a boron-containing material in an amount of not greater than 5 wt. %, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. %.

Embodiment 33. The article of any one of embodiments 1, 2, 4, or 5, wherein the body comprises a boron-containing material including boron and at least one material from the group of silicon, carbon, or any combination thereof.

Embodiment 34. The article of any one of embodiments 31, 32, or 33, wherein the boron-containing material includes boron carbide.

Embodiment 35. The article of embodiment 34, wherein the boron-containing material consists essentially of boron carbide.

Embodiment 36. The article of embodiment 35, wherein the boron-containing material consists of boron carbide and no other boron-containing or carbide-containing species.

Embodiment 37. The article of any one of embodiments 1, 2, 4, or 5, wherein the body comprises an oxygen-containing material in an amount of at least 0.1 wt. % for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body.

Embodiment 38. The article of any one of embodiments 1, 2, 4, or 5, wherein the body comprises an oxygen-containing material in an amount of not greater than 5 wt. %, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. %.

Embodiment 39. The article of any one of embodiments 1, 2, 4, or 5, wherein the body comprises an aluminum-containing material in an amount of at least 0.01 wt. % for a total weight of the body, or at least 0.02 wt. %, or at least 0.03 wt. %, or at least 0.04 wt. %, or at least 0.05 wt. %, or at least 0.06 wt. %, or at least 0.07 wt. %, or at least 0.08 wt. %, or at least 0.09 wt. %, or at least 0.1 wt. % for a total weight of the body.

Embodiment 40. The article of any one of embodiments 1, 2, 4, or 5, wherein the body comprises an aluminum-containing material in an amount of not greater than 0.1 wt. %, or not greater than 0.09 wt. %, or not greater than 0.08 wt. %, or not greater than 0.07 wt. %, or not greater than 0.06 wt. %, or not greater than 0.05 wt. %, or not greater than 0.04 wt. %, or not greater than 0.03 wt. %, or not greater than 0.02 wt. %, or not greater than 0.01 wt. %.

Embodiment 41. The article of any one of embodiments 1, 2, 4, or 5, wherein the body comprises free carbon in an amount of at least 0.1 wt. % for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body.

Embodiment 42. The article of any one of embodiments 1, 2, 4, or 5, wherein the body free carbon in an amount of not greater than 5 wt. %, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. %.

Embodiment 43. The article of any one of embodiments 1, 2, 4, or 5, wherein the body comprises free metals in an amount of at least 0.01 wt. % for a total weight of the body, or at least 0.02 wt. %, or at least 0.03 wt. %, or at least 0.04 wt. %, or at least 0.05 wt. %, or at least 0.06 wt. %, or at least 0.07 wt. %, or at least 0.08 wt. %, or at least 0.09 wt. %, or at least 0.1 wt. % for a total weight of the body.

Embodiment 44. The article of any one of embodiments 1, 2, 4, or 5, wherein the body free metals in an amount of not greater than 0.1 wt. %, or not greater than 0.09 wt. %, or not greater than 0.08 wt. %, or not greater than 0.07 wt. %, or not greater than 0.06 wt. %, or not greater than 0.05 wt. %, or not greater than 0.04 wt. %, or not greater than 0.03 wt. %, or not greater than 0.02 wt. %, or not greater than 0.01 wt. %.

Embodiment 45. The article of any one of embodiments 1, 2, 4, or 5, wherein the body comprises trace amounts of calcium, iron, titanium, vanadium, or a combination thereof.

Embodiment 46. The article of any one of embodiments 1, 2, 4, or 5, wherein the body comprises trace amounts of calcium, iron, titanium, and vanadium.

Embodiment 47. The article of any one of embodiments 1, 2, 4, or 5, wherein the ratio of the mean pore spacing to median pore size, (mean pore spacing)/(D50p), is at least 1.0, or at least 1.1, or at least 1.2, or at least 1.3, or at least 1.4, or at least 1.5, or at least 1.6, or at least 1.7, or at least 1.8, or at least 1.9, or at least 2.0, or at least 2.1, or at least 2.2, or at least 2.3, or at least 2.4, or at least 2.5, or at least 2.6, or at least 2.7, or at least 2.8, or at least 2.9, or at least 3.0, or at least 3.1, or at least 3.2, or at least 3.3, or at least 3.4, or at least 3.5, or at least 3.6, or at least 3.7, or at least 3.8, or at least 3.9, or at least 4.0, or at least 4.1, or at least 4.2, or at least 4.3, or at least 4.4, or at least 4.5, or at least 4.6.

Embodiment 48. The article of any one of embodiments 1, 2, 4, or 5, wherein the ratio of the mean pore spacing to median pore size, (mean pore spacing)/(D50p), is not greater than 10, or not greater than 9, or not greater than 8, or not greater than 7, or not greater than 6, or not greater than 5.

Embodiment 49. The article of any one of embodiments 1, 2, 4, or 5, wherein the ratio of the median pore spacing to median pore size, (D50d)/D50p, is at least 1.0, or at least 1.1, or at least 1.2, or at least 1.3, or at least 1.4, or at least 1.5, or at least 1.6, or at least 1.7, or at least 1.8, or at least 1.9, or at least 2.0, or at least 2.1, or at least 2.2, or at least 2.3, or at least 2.4, or at least 2.5, or at least 2.6, or at least 2.7, or at least 2.8, or at least 2.9, or at least 3.0, or at least 3.1, or at least 3.2, or at least 3.3, or at least 3.4, or at least 3.5, or at least 3.6, or at least 3.7, or at least 3.8, or at least 3.9, or at least 4.0, or at least 4.1, or at least 4.2, or at least 4.3, or at least 4.4.

Embodiment 50. The article of any one of embodiments 1, 2, 4, or 5, wherein the ratio of the median pore spacing to median pore size, (D50d)/D50p, is not greater than 10, or not greater than 9, or not greater than 8, or not greater than 7, or not greater than 6, or not greater than 5.

Embodiment 51. The article of any one of embodiments 1, 2, 4, or 5, wherein the pores comprise at least 0.5 vol % pores for a total volume of the body, or at least 0.6 vol %, or at least 0.7 vol %, or at least 0.8 vol %, or at least 0.9 vol %, or at least 1.0 vol % vol %, or at least 1.1 vol %, or at least 1.2 vol %, or at least 1.3 vol %, or at least 1.4 vol %, or at least 1.5 .vol %, or at least 1.6 vol %, or at least 1.7 vol %, or at least 1.8 vol %, or at least 1.9 vol %, 2.0 vol %, or at least 2.1 vol %, or at least 2.2 vol %, or at least 2.3 vol %, or at least 2.4 vol %, or at least 2.5 .vol %, or at least 2.6 vol %, or at least 2.7 vol %, or at least 2.8 vol %, or at least 2.9 vol %, or at least 3.0 vol % of the volume of the body.

Embodiment 52. The article of any one of embodiments 1, 2, 4, or 5, wherein the pores comprise no greater than 5 vol % of the volume of the body, or not greater than 4.8 vol %, or not greater than 4.6 vol %, or not greater than 4.4 vol %, or not greater than 4.2 vol %, or not greater than 4.0 vol %, or not greater than 3.8 vol %, or not greater than 3.74 vol %, or not greater than 3.6 vol %, or not greater than 3.4 vol %, or not greater than 3.2 vol %, or not greater than 3.0 vol % of the volume of the body.

Embodiment 53. The article of any one of embodiments 1, 2, 4, or 5, wherein at least 50% of all porosity is closed porosity or at least 60%, or at least 70%, or at least 80%, or at least 90%, or at least 95%, or at least 97%, or essentially all of the porosity in the body is closed porosity.

Embodiment 54. The article of any one of embodiments 1, 2, 4, or 5, wherein the body comprises a density of at least 2.00 g/cm3, or at least 2.05 g/cm3, or at least 2.10 g/cm3, or at least 2.15 g/cm3, or at least 2.20 g/cm3, or at least 2.25 g/cm3, or at least 2.30 g/cm3, or at least 2.35 g/cm3, or at least 2.40 g/cm3, or at least 2.45 g/cm3, or at least 2.50 g/cm3, or at least 2.55 g/cm3, or at least 2.60 g/cm3, or at least 2.65 g/cm3, or at least 2.70 g/cm3, or at least 2.75 g/cm3, or at least 2.80 g/cm3, or at least 2.85 g/cm3, or at least 2.90 g/cm3, or at least 2.95 g/cm3, or at least 3.0 g/cm3, or at least 3.01 g/cm3, or at least 3.02 g/cm3, or at least 3.03 g/cm3, or at least 3.04 g/cm3, or at least 3.05 g/cm3, or at least 3.06 g/cm3, or at least 3.07 g/cm3, or at least 3.08 g/cm3, or at least 3.09 g/cm3.

Embodiment 55. The article of any one of embodiments 1, 2, 4, or 5, wherein the body comprises a density of no greater than 4.00 g/cm3, or no greater than 3.95 g/cm3, or no greater than 3.90 g/cm3, or no greater than 3.85 g/cm3, or no greater than 3.80 g/cm3, or no greater than 3.75 g/cm3, or no greater than 3.70 g/cm3, or no greater than 3.65 g/cm3, or no greater than 3.60 g/cm3, or no greater than 3.55 g/cm3, or no greater than 3.50 g/cm3, or no greater than 3.45 g/cm3, or no greater than 3.40 g/cm3, or no greater than 3.35 g/cm3, or no greater than 3.30 g/cm3, or no greater than 3.25 g/cm3, or no greater than 3.20 g/cm3 or no greater than 3.19 g/cm3, or no greater than 3.18 g/cm3, or no greater than 3.17 g/cm3, or no greater than 3.16 g/cm3, or no greater than 3.15 g/cm3, or no greater than 3.14 g/cm3, or no greater than 3.13 g/cm3.

Embodiment 56. The article of any one of embodiments 1, 2, 4, or 5, wherein the body comprises SiC having an average crystal size of at least 1 micron, or at least 1.5 microns, or at least 2 microns, or at least 2.5 microns, or at least 3 microns, or at least 3.5 microns, or at least 4 microns.

Embodiment 57. The article of any one of embodiments 1, 2, 4, or 5, wherein the body comprises SiC having an average crystal size of no greater than 15 microns, or no greater than 14 microns, or no greater than 13 microns, or no greater than 12 microns, or no greater than 11 microns, or no greater than 10 microns.

Embodiment 58. The article of any one of embodiments 1, 2, 4, or 5, wherein the body has a hardness of at least 2000 Knoop, or at least 2100 Knoop, or at least 2200 Knoop, or at least 2300 Knoop, or at least 2400 Knoop, or at least 2500 Knoop, or at least 2600 Knoop, or at least 2700 Knoop.

Embodiment 59. The article of any one of embodiments 1, 2, 4, or 5, wherein the body has a hardness of not greater than 3500 Knoop, or not greater than 3400 Knoop, or not greater than 3300 Knoop, or not greater than 3200 Knoop, or not greater than 3100 Knoop, or not greater than 3000 Knoop, or not greater than 2900 Knoop.

Embodiment 60. The article of any one of embodiments 1, 2, 4, or 5, wherein the body has a fracture toughness of at least 3.0 MPa m1/2, or at least 3.1 MPa m1/2, or at least 3.2 MPa m1/2, or at least 3.3 MPa m1/2, or at least 3.4 MPa m1/2, or at least 3.5 MPa m1/2, or at least 3.6 MPa m1/2, or at least 3.7 MPa m1/2, or at least 3.8 MPa m1/2, or at least 3.9 MPa m1/2, or at least 4.0 MPa m1/2.

Embodiment 61. The article of any one of embodiments 1, 2, 4, or 5, wherein the body has a fracture toughness of no greater than 5.0 MPa m1/2, or no greater than 4.9 MPa m1/2, or no greater than 4.8 MPa m1/2, or no greater than 4.7 MPa m1/2, or no greater than 4.6 MPa m1/2, or no greater than 4.5 MPa m1/2.

Embodiment 62. The article of any one of embodiments 1, 2, 4, or 5, wherein the body has a 4 pt flexural strength of at least 100 MPa, or at least 110 MPa, or at least 120 MPa, or at least 130 MPa, or at least 140 MPa, or at least 150 MPa, or at least 160 MPa, or at least 170 MPa, or at least 180 MPa, or at least 190 MPa, or at least 200 MPa, or at least 210 MPa, or at least 220 MPa.

Embodiment 63. The article of any one of embodiments 1, 2, 4, or 5, wherein the body has a 4 pt flexural strength of no greater than 400 MPa, or no greater than 380 MPa, or no greater than 360 MPa, or no greater than 340 MPa, or no greater than 320 MPa, or no greater than 300 MPa, or no greater than 280 MPa, or no greater than 260 MPa.

Embodiment 64. The article of any one of embodiments 1, 2, 4, or 5, wherein the body has an MOE of at least 100 GPa, or at least 125 GPa, or at least 150 GPa, or at least 175 GPa, or at least 200 GPa, or at least 225 GPa, or at least 250 GPa, or at least 275 GPa, or at least 300 GPa, at least 325 GPa, or at least 350 GPa.

Embodiment 65. The article of any one of embodiments 1, 2, 4, or 5, wherein the body has an MOE of no greater than 700 GPa, or no greater than 675 GPa, or no greater than 650 GPa, or no greater than 625 GPa, or no greater than 600 GPa, or no greater than 575 GPa, or no greater than 550 GPa, or no greater than 525 GPa, or no greater than 500 GPa, or no greater than 475 GPa, or no greater than 450 GPa.

Embodiment 66. The article of any one of embodiments 1, 2, 4, or 5, wherein the body has a ballistic limit velocity V50 of at least 767 m/s, or at least 768 m/s, or at least 769 m/s, or at least 770 m/s, or at least 771 m/s, or at least 772 m/s, or at least 773 m/s, or at least 774 m/s, or at least 775 m/s, or at least 776 m/s, or at least 777 m/s, or at least 778 m/s, or at least m/s, or at least 779 m/s, or at least 780 m/s, or at least 781 m/s, or at least 782 m/s, or at least 783 m/s, or at least 784 m/s, or at least 785 m/s.

Embodiment 67. The article of any one of embodiments 1, 2, 4, or 5, wherein the body has a ballistic limit velocity V50 of not greater than 900 m/s, or not greater than 875 m/s, or not greater than 850 m/s, or not greater than 840 m/s, or not greater than 830 m/s, or not greater than 820 m/s, or not greater than 815 m/s, or not greater than 810 m/s, or not greater than 805 m/s, or not greater than 800 m/s.

Embodiment 68. The article of any one of embodiments 1, 2, 4, or 5, comprising any combination of the features embodied herein.

Embodiment 69. A method of forming an article comprising:

providing a mixture comprising silicon carbide and pore formers;

shaping or pressing the mixture to form a green body;

sintering the green body to produce an article comprising a body including silicon carbide and pores;

wherein the pores have a mean spacing distance of at least 205 microns and not greater than 300 microns.

Embodiment 70. The method of embodiment 69, wherein the green body is sintered at a maximum temperature of at least 1500° C., or at least 1600° C., or at least 1700° C., or at least 1750° C., or at least 1800° C., or at least 1850° C., or at least 1900° C. or at least 1950° C. or at least 2000° C., or at least 2025° C., or at least 2050° C., or at least 2075° C., or at least 2100° C., or at least 2125° C.

Embodiment 71. The method of embodiment 69, wherein the green body is sintered at a maximum temperature of no greater than 2500° C., or no greater than 2450° C., or no greater than 2400° C., or no greater than 2350° C., or no greater than 2300° C., or no greater than 2250° C., or no greater than 2200° C.

Embodiment 72. The method of embodiment 70, wherein the green body is sintered at the maximum temperature for at least 30 minutes, or at least 45 minutes, or at least 60 minutes, or at least 75 minutes, or at least 90 minutes, or at least 105 minutes, or at least 120 minutes, or at least 135 minutes, or at least 150 minutes.

Embodiment 73. The method of embodiment 70, wherein the green body is sintered at the maximum temperature for no greater than 600 minutes, or no greater than 570 minutes, or no greater than 540 minutes, or no greater than 510 minutes, or no greater than 480 minutes, or no greater than 450 minutes, or no greater than 420 minutes, or no greater than 390 minutes, or no greater than 360 minutes, or no greater than 330 minutes, or no greater than 300 minutes, or no greater than 270 minutes, or no greater than 240 minutes.

Embodiment 74. The method of embodiment 69, wherein the article comprises at least 0.5 vol % and not greater than 4 vol % porosity.

Embodiment 75. The method of embodiment 69, wherein the article comprises a ballistic limit velocity V50 of at least 766 m/s.

Embodiment 76. The method of embodiment 69, wherein the article comprises a ratio of the median pore spacing to median pore size, (D50d)/D50p, of at least 3.2.

Embodiment 77. The method of embodiment 69, wherein the pores have a median size, D50p, least 10 microns, or at least 12 microns, or at least 14 microns, or at least 16 microns, or at least 18 microns, or at least 20 microns, or at least 22 microns, or at least 24 microns, or at least 26 microns, or at least 28 microns, or at least 30 microns, or at least 32 microns, or at least 34 microns, or at least 36 microns, or at least 38 microns, or at least 40 microns, or at least 42 microns, or at least 44 microns, or at least 46 microns, or at least 48 microns.

Embodiment 78. The method of embodiment 69, wherein the pores have a median size, D50p, of no greater than 100 microns, or no greater than 95 microns, or no greater than 90 microns, or no greater than 85 microns, or no greater than 80 microns, or no greater than 75 microns, or no greater than 70 microns, or no greater than 65 microns, or no greater than 62 microns, or no greater than 61 microns, or no greater than 60 microns, or no greater than 59 microns, or no greater than 58 microns, or no greater than 57 microns, or no greater than 56 microns, or no greater than 55 microns, or no greater than 54 microns, or no greater than 53 microns, or no greater than 52 microns, or no greater than 51 microns.

Embodiment 79. The method of embodiment 69, wherein the pores have a mean spacing distance of at least 206 microns, or at least 207 microns, or at least 208 microns, or at least 209 microns, or at least 210 microns, or at least 211 microns, or at least 212 microns, or at least 213 microns, or at least 214 microns, or at least 215 microns, or at least 216 microns, or at least 217 microns, or at least 218 microns, or at least 219 microns, or at least 220 microns, or at least 221 microns, or at least 222 microns, or at least 223 microns, or at least 224 microns, or at least 225 microns.

Embodiment 80. The method of embodiment 69, wherein the pores have a mean spacing distance of not greater than 300 microns, or not greater than 295 microns, or not greater than 290 microns, or not greater than 285 microns, or not greater than 280 microns, or not greater than 275 microns, or not greater than 270 microns, or not greater than 265 microns, or not greater than 260 microns.

Embodiment 81. The method of embodiment 69, wherein the pores have a spacing distance standard deviation of not greater than 90, or not greater than 89, or not greater than 88, or not greater than 87, or not greater than 86, or not greater than 85, or not greater than 84, or not greater than 83, or not greater than 82, or not greater than 81, or not greater than 80, or not greater than 79, or not greater than 78, or not greater than 77, or not greater than 76, or not greater than 75.

Embodiment 82. The method of embodiment 69, wherein the pores have a spacing distance standard deviation of at least 60, or at least 61, or at least 62, or at least 63, or at least 64, or at least 65, or at least 66, or at least 67, or at least 68, or at least 69, or at least 70, or at least 71, or at least 72.

Embodiment 83. The method of embodiment 69, wherein the median distance between the pores D50d, is at least 190 microns, or at least 191 microns, or at least 192 microns, or at least 193 microns, or at least 194 microns, or at least 195 microns, or at least 196 microns, or at least 197 microns, or at least 198 microns, or at least 199 microns, or at least 200 microns, or at least 201 microns, or at least 202 microns, or at least 203 microns, or at least 204 microns, or at least 205 microns, or at least 206 microns, or at least 207 microns, or at least 208 microns, or at least 209 microns, or at least 210 microns, or at least 211 microns, or at least 212 microns, or at least 213 microns, or at least 214 microns, or at least 215 microns, or at least 216 microns, or at least 217 microns, or at least 218 microns, or at least 219 microns, or at least 220 microns.

Embodiment 84. The method of embodiment 69, wherein the median distance between the pores D50d is not greater than 500 microns, or not greater than 450 microns, or not greater than 300 microns, or not greater than 295 microns, or not greater than 290 microns, or not greater than 285 microns, or not greater than 280 microns, or not greater than 275 microns, or not greater than 270 microns, or not greater than 265 microns, or not greater than 260 microns, or not greater than 255 microns, or not greater than 250 microns.

Embodiment 85. The method of embodiment 69, wherein D25d, is at least 150 microns, or at least 151 microns, or at least 152 microns, or at least 153 microns, or at least 154 microns, or at least 155 microns, or at least 156 microns, or at least 157 microns, or at least 158 microns, or at least 159 microns, or at least 160 microns, or at least 161 microns, or at least 162 microns, or at least 163 microns, or at least 164 microns, or at least 165 microns.

Embodiment 86. The method of embodiment 69, wherein D25d is not greater than 300 microns, or not greater than 290 microns, or not greater than 280 microns, or not greater than 270 microns, or not greater than 260 microns, or not greater than 250 microns, or not greater than 240 microns, or not greater than 230 microns, or not greater than 220 microns, or not greater than 210 microns, or not greater than 200 microns.

Embodiment 87. The method of embodiment 69, wherein D10d is at least 110 microns, or at least 111 microns, or at least 112 microns, or at least 113 microns, or at least 114 microns, or at least 115 microns.

Embodiment 88. The method of embodiment 69, wherein D10d is not greater than 200 microns, or not greater than 190 microns, or not greater than 180 microns, or not greater than 170 microns, or not greater than 160 microns, or not greater than 150 microns, or not greater than 140 microns, or not greater than 130 microns.

Embodiment 89. The method of embodiment 69, wherein D5d, is at least 90 microns, or at least 91 microns, or at least 92 microns, or at least 93 microns, or at least 94 microns, or at least 95 microns.

Embodiment 90. The method of embodiment 69, D5d is not greater than 150 microns, or not greater than 145 microns, or not greater than 140 microns, or not greater than 135 microns, or not greater than 130 microns, or not greater than 125 microns, or not greater than 120 microns.

Embodiment 91. The method of embodiment 69, wherein D75d, is at least 235 microns, or at least 240 microns, or at least 245 microns, or at least 250 microns, or at least 255 microns, or at least 260 microns, or at least 265 microns.

Embodiment 92. The method of embodiment 69, wherein D75d is not greater than 500 microns, or not greater than 480 microns, or not greater than 460 microns, or not greater than 440 microns, or not greater than 420 microns, or not greater than 400 microns, or not greater than 380 microns, or not greater than 360 microns, or not greater than 340 microns, or not greater than 330 microns, or not greater than 320 microns, or not greater than 310 microns, or not greater than 300 microns, or not greater than 295 microns, or not greater than 290 microns, or not greater than 285 microns, or not greater than 280 microns.

Embodiment 93. The method of embodiment 69, wherein D90d, is at least 270 microns, or at least 275 microns, or at least 280 microns, or at least 285 microns, or at least 290 microns, or at least 295 microns, or at least 300 microns, or at least 305 microns.

Embodiment 94. The method of embodiment 69, wherein D90d is not greater than 600 microns, or not greater than 550 microns, or not greater than 500 microns, or not greater than 450 microns, or not greater than 400 microns, or not greater than 380 microns, or not greater than 360 microns, or not greater than 350 microns, or not greater than 345 microns, or not greater than 340 microns, or not greater than 335 microns, or not greater than 330 microns, or not greater than 325 microns.

Embodiment 95. The method of embodiment 69, wherein D95d, is at least 290 microns, or at least 295 microns, or at least 300 microns, or at least 305 microns, or at least 310 microns, or at least 315 microns, or at least 320 microns, or at least 325 microns, or at least 330 microns, or at least 335 microns.

Embodiment 96. The method of embodiment 69, wherein D95d is not greater than 600 microns, or not greater than 550 microns, or not greater than 500 microns, or not greater than 450 microns, or not greater than 400 microns, or not greater than 380 microns, or not greater than 375 microns, or not greater than 370 microns, or not greater than 365 microns, or not greater than 360 microns, or not greater than 355 microns, or not greater than 350 microns.

Embodiment 97. The method of embodiment 69, wherein the body comprises at least 90 wt. % SiC for a total weight of the body, or at least 91 wt. %, or at least 92 wt. %, or at least 93 wt. %, or at least 94 wt. %, or at least 95 wt. %, or at least 96 wt. %, or at least 97 wt. %, or at least 98 wt. % SiC for a total weight of the body.

Embodiment 98. The method of embodiment 69, wherein the body comprises no greater than 99.99 wt. % SiC for a total weight of the body, or not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % SiC for a total weight of the body.

Embodiment 99. The method of embodiment 69, wherein a majority of the silicon carbide within in the body is alpha phase silicon carbide, or at least 60 wt. % of all silicon carbide in the body is alpha phase silicon carbide, or at least 62 wt. %, or at least 64 wt. %, or at least 66 wt. %, or at least 68 wt. %, or at least 70 wt. %, or at least 72 wt. %, or at least 74 wt. %, or at least 76 wt. %, or at least 78 wt. %, or at least 80 wt. %, or at least 82 wt. %, or at least 84 wt. %, or at least 86 wt. %, or at least 88 wt. %, or at least 90 wt. %, or at least 92 wt. %, or at least 94 wt. %, or at least 96 wt. %, or at least 98 wt. % alpha phase silicon carbide, or essentially all of the silicon carbide in the body is alpha phase silicon carbide.

Embodiment 100. The method of embodiment 69, wherein the body comprises no greater than 99.99 wt. % of the silicon carbide within the body is alpha phase silicon carbide, or not greater than 99.95 wt. %, or no greater than 99.9 wt. %, or no greater than 99.8 wt. %, or no greater than 99.5 wt. %, or no greater than 99 wt. %, or no greater than 98 wt. %, or no greater than 97 wt. %, or no greater than 96 wt. %, or no greater than 95 wt. % of the silicon carbide is alpha phase silicon carbide.

Embodiment 101. The method of embodiment 69, wherein a majority of the silicon carbide in the body comprises an aspect ratio (1:w) as viewed in cross-section of not greater than 3:1, or not greater than 2.5:1, or not greater than 2.3:1, or not greater than 2.1:1, or not greater than 2:1, or not greater than 1.9:1, or not greater than 1.8:1, or not greater than 1.7:1, or not greater than 1.6:1, or not greater than 1.5:1, or not greater than 1.4:1, or not greater than 1.3:1, or not greater than 1.2:1.

Embodiment 102. The method of embodiment 69, wherein the body comprises a boron-containing material in an amount of at least 0.1 wt. % for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body.

Embodiment 103. The method of embodiment 69, wherein the body comprises a boron-containing material in an amount of not greater than 5 wt. %, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. %.

Embodiment 104. The method of embodiment 69, wherein the body comprises a boron-containing material including boron and at least one material from the group of silicon, carbon, or any combination thereof.

Embodiment 105. The method of any one of embodiments 102, 103, or 104, wherein the boron-containing material includes boron carbide.

Embodiment 106. The method of embodiment 105, wherein the boron-containing material consists essentially of boron carbide.

Embodiment 107. The method of embodiment 106, wherein the boron-containing material consists of boron carbide and no other boron-containing or carbide-containing species.

Embodiment 108. The method of embodiment 69, wherein the body comprises an oxygen-containing material in an amount of at least 0.1 wt. % for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body.

Embodiment 109. The method of embodiment 69, wherein the body comprises an oxygen-containing material in an amount of not greater than 5 wt. %, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. %.

Embodiment 110. The method of embodiment 69, wherein the body comprises an aluminum-containing material in an amount of at least 0.01 wt. % for a total weight of the body, or at least 0.02 wt. %, or at least 0.03 wt. %, or at least 0.04 wt. %, or at least 0.05 wt. %, or at least 0.06 wt. %, or at least 0.07 wt. %, or at least 0.08 wt. %, or at least 0.09 wt. %, or at least 0.1 wt. % for a total weight of the body.

Embodiment 111. The method of embodiment 69, wherein the body comprises an aluminum-containing material in an amount of not greater than 0.1 wt. %, or not greater than 0.09 wt. %, or not greater than 0.08 wt. %, or not greater than 0.07 wt. %, or not greater than 0.06 wt. %, or not greater than 0.05 wt. %, or not greater than 0.04 wt. %, or not greater than 0.03 wt. %, or not greater than 0.02 wt. %, or not greater than 0.01 wt. %.

Embodiment 112. The method of embodiment 69, wherein the body comprises free carbon in an amount of at least 0.1 wt. % for a total weight of the body, or at least 0.2 wt. %, or at least 0.3 wt. %, or at least 0.4 wt. %, or at least 0.5 wt. %, or at least 0.6 wt. %, or at least 0.7 wt. %, or at least 0.8 wt. %, or at least 0.9 wt. %, or at least 1.0 wt. %, or at least 1.1 wt. %, or at least 1.2 wt. %, or at least 1.3 wt. %, or at least 1.4 wt. %, or at least 1.5 wt. %, or at least 1.6 wt. %, or at least 1.7 wt. %, or at least 1.8 wt. %, or at least 1.9 wt. %, 2.0 wt. %, or at least 2.1 wt. %, or at least 2.2 wt. %, or at least 2.3 wt. %, or at least 2.4 wt. %, or at least 2.5 wt. %, or at least 2.6 wt. %, or at least 2.7 wt. %, or at least 2.8 wt. %, or at least 2.9 wt. %, 3.0 wt. %, or at least 3.1 wt. %, or at least 3.2 wt. %, or at least 3.3 wt. %, or at least 3.4 wt. %, or at least 3.5 wt. %, or at least 3.6 wt. %, or at least 3.7 wt. %, or at least 3.8 wt. %, or at least 3.9 wt. %, 4.0 wt. %, or at least 4.1 wt. %, or at least 4.2 wt. %, or at least 4.3 wt. %, or at least 4.4 wt. %, or at least 4.5 wt. %, or at least 4.6 wt. %, or at least 4.7 wt. %, or at least 4.8 wt. %, or at least 4.9 wt. %, or at least 5.0 wt. % for a total weight of the body.

Embodiment 113. The method of embodiment 69, wherein the body free carbon in an amount of not greater than 5 wt. %, or not greater than 4.8 wt. %, or not greater than 4.6 wt. %, or not greater than 4.4 wt. %, or not greater than 4.2 wt. %, or not greater than 4.0 wt. %, or not greater than 3.8 wt. %, or not greater than 3.6 wt. %, or not greater than 3.4 wt. %, or not greater than 3.2 wt. %, or not greater than 3.0 wt. %, or not greater than 2.8 wt. %, or not greater than 2.6 wt. %, or not greater than 2.4 wt. %, or not greater than 2.2 wt. %, or not greater than 2.0 wt. %, or not greater than 1.8 wt. %, or not greater than 1.6 wt. %, or not greater than 1.4 wt. %, or not greater than 1.2 wt. %, or not greater than 1.0 wt. %, or not greater than 0.8 wt. %, or not greater than 0.6 wt. %, or not greater than 0.4 wt. %, or not greater than 0.2 wt. %.

Embodiment 114. The method of embodiment 69, wherein the body comprises free metals in an amount of at least 0.01 wt. % for a total weight of the body, or at least 0.02 wt. %, or at least 0.03 wt. %, or at least 0.04 wt. %, or at least 0.05 wt. %, or at least 0.06 wt. %, or at least 0.07 wt. %, or at least 0.08 wt. %, or at least 0.09 wt. %, or at least 0.1 wt. % for a total weight of the body.

Embodiment 115. The method of embodiment 69, wherein the body free metals in an amount of not greater than 0.1 wt. %, or not greater than 0.09 wt. %, or not greater than 0.08 wt. %, or not greater than 0.07 wt. %, or not greater than 0.06 wt. %, or not greater than 0.05 wt. %, or not greater than 0.04 wt. %, or not greater than 0.03 wt. %, or not greater than 0.02 wt. %, or not greater than 0.01 wt. %.

Embodiment 116. The method of embodiment 69, wherein the body comprises trace amounts of calcium, iron, titanium, vanadium, or a combination thereof.

Embodiment 117. The method of embodiment 69, wherein the body comprises trace amounts of calcium, iron, titanium, and vanadium.

Embodiment 118. The method of embodiment 69, wherein the ratio of the mean pore spacing to median pore size, (mean pore spacing)/(D50p), is at least 1.0, or at least 1.1, or at least 1.2, or at least 1.3, or at least 1.4, or at least 1.5, or at least 1.6, or at least 1.7, or at least 1.8, or at least 1.9, or at least 2.0, or at least 2.1, or at least 2.2, or at least 2.3, or at least 2.4, or at least 2.5, or at least 2.6, or at least 2.7, or at least 2.8, or at least 2.9, or at least 3.0, or at least 3.1, or at least 3.2, or at least 3.3, or at least 3.4, or at least 3.5, or at least 3.6, or at least 3.7, or at least 3.8, or at least 3.9, or at least 4.0, or at least 4.1, or at least 4.2, or at least 4.3, or at least 4.4, or at least 4.5, or at least 4.6.

Embodiment 119. The method of embodiment 69, wherein the ratio of the mean pore spacing to median pore size, (mean pore spacing)/(D50p), is not greater than 10, or not greater than 9, or not greater than 8, or not greater than 7, or not greater than 6, or not greater than 5.

Embodiment 120. The method of embodiment 69, wherein the ratio of the median pore spacing to median pore size, (D50d)/D50p, is at least 1.0, or at least 1.1, or at least 1.2, or at least 1.3, or at least 1.4, or at least 1.5, or at least 1.6, or at least 1.7, or at least 1.8, or at least 1.9, or at least 2.0, or at least 2.1, or at least 2.2, or at least 2.3, or at least 2.4, or at least 2.5, or at least 2.6, or at least 2.7, or at least 2.8, or at least 2.9, or at least 3.0, or at least 3.1, or at least 3.2, or at least 3.3, or at least 3.4, or at least 3.5, or at least 3.6, or at least 3.7, or at least 3.8, or at least 3.9, or at least 4.0, or at least 4.1, or at least 4.2, or at least 4.3, or at least 4.4.

Embodiment 121. The method of embodiment 69, wherein the ratio of the median pore spacing to median pore size, (D50d)/D50p, is not greater than 10, or not greater than 9, or not greater than 8, or not greater than 7, or not greater than 6, or not greater than 5.

Embodiment 122. The method of embodiment 69, wherein the pores comprise at least 0.5 vol % pores for a total volume of the body, or at least 0.6 vol %, or at least 0.7 vol %, or at least 0.8 vol %, or at least 0.9 vol %, or at least 1.0 vol % vol %, or at least 1.1 vol %, or at least 1.2 vol %, or at least 1.3 vol %, or at least 1.4 vol %, or at least 1.5 .vol %, or at least 1.6 vol %, or at least 1.7 vol %, or at least 1.8 vol %, or at least 1.9 vol %, 2.0 vol %, or at least 2.1 vol %, or at least 2.2 vol %, or at least 2.3 vol %, or at least 2.4 vol %, or at least 2.5 .vol %, or at least 2.6 vol %, or at least 2.7 vol %, or at least 2.8 vol %, or at least 2.9 vol %, or at least 3.0 vol % of the volume of the body.

Embodiment 123. The method of embodiment 69, wherein the pores comprise no greater than 5 vol % of the volume of the body, or not greater than 4.8 vol %, or not greater than 4.6 vol %, or not greater than 4.4 vol %, or not greater than 4.2 vol %, or not greater than 4.0 vol %, or not greater than 3.8 vol %, or not greater than 3.74 vol %, or not greater than 3.6 vol %, or not greater than 3.4 vol %, or not greater than 3.2 vol %, or not greater than 3.0 vol % of the volume of the body.

Embodiment 124. The method of embodiment 69, wherein at least 50% of all porosity is closed porosity or at least 60%, or at least 70%, or at least 80%, or at least 90%, or at least 95%, or at least 97%, or essentially all of the porosity in the body is closed porosity.

Embodiment 125. The method of embodiment 69, wherein the body comprises a density of at least 2.00 g/cm3, or at least 2.05 g/cm3, or at least 2.10 g/cm3, or at least 2.15 g/cm3, or at least 2.20 g/cm3, or at least 2.25 g/cm3, or at least 2.30 g/cm3, or at least 2.35 g/cm3, or at least 2.40 g/cm3, or at least 2.45 g/cm3, or at least 2.50 g/cm3, or at least 2.55 g/cm3, or at least 2.60 g/cm3, or at least 2.65 g/cm3, or at least 2.70 g/cm3, or at least 2.75 g/cm3, or at least 2.80 g/cm3, or at least 2.85 g/cm3, or at least 2.90 g/cm3, or at least 2.95 g/cm3, or at least 3.0 g/cm3, or at least 3.01 g/cm3, or at least 3.02 g/cm3, or at least 3.03 g/cm3, or at least 3.04 g/cm3, or at least 3.05 g/cm3, or at least 3.06 g/cm3, or at least 3.07 g/cm3, or at least 3.08 g/cm3, or at least 3.09 g/cm3.

Embodiment 126. The method of embodiment 69, wherein the body comprises a density of no greater than 4.00 g/cm3, or no greater than 3.95 g/cm3, or no greater than 3.90 g/cm3, or no greater than 3.85 g/cm3, or no greater than 3.80 g/cm3, or no greater than 3.75 g/cm3, or no greater than 3.70 g/cm3, or no greater than 3.65 g/cm3, or no greater than 3.60 g/cm3, or no greater than 3.55 g/cm3, or no greater than 3.50 g/cm3, or no greater than 3.45 g/cm3, or no greater than 3.40 g/cm3, or no greater than 3.35 g/cm3, or no greater than 3.30 g/cm3, or no greater than 3.25 g/cm3, or no greater than 3.20 g/cm3 or no greater than 3.19 g/cm3, or no greater than 3.18 g/cm3, or no greater than 3.17 g/cm3, or no greater than 3.16 g/cm3, or no greater than 3.15 g/cm3, or no greater than 3.14 g/cm3, or no greater than 3.13 g/cm3.

Embodiment 127. The method of embodiment 69, wherein the body comprises SiC having an average crystal size of at least 1 micron, or at least 1.5 microns, or at least 2 microns, or at least 2.5 microns, or at least 3 microns, or at least 3.5 microns, or at least 4 microns.

Embodiment 128. The method of embodiment 69, wherein the body comprises SiC having an average crystal size of no greater than 15 microns, or no greater than 14 microns, or no greater than 13 microns, or no greater than 12 microns, or no greater than 11 microns, or no greater than 10 microns.

Embodiment 129. The method of embodiment 69, wherein the body has a hardness of at least 2000 Knoop, or at least 2100 Knoop, or at least 2200 Knoop, or at least 2300 Knoop, or at least 2400 Knoop, or at least 2500 Knoop, or at least 2600 Knoop, or at least 2700 Knoop.

Embodiment 130. The method of embodiment 69, wherein the body has a hardness of not greater than 3500 Knoop, or not greater than 3400 Knoop, or not greater than 3300 Knoop, or not greater than 3200 Knoop, or not greater than 3100 Knoop, or not greater than 3000 Knoop, or not greater than 2900 Knoop.

Embodiment 131. The method of embodiment 69, wherein the body has a fracture toughness of at least 3.0 MPa m1/2, or at least 3.1 MPa m1/2, or at least 3.2 MPa m1/2, or at least 3.3 MPa m1/2, or at least 3.4 MPa m1/2, or at least 3.5 MPa m1/2, or at least 3.6 MPa m1/2, or at least 3.7 MPa m1/2, or at least 3.8 MPa m1/2, or at least 3.9 MPa m1/2, or at least 4.0 MPa m1/2.

Embodiment 132. The method of embodiment 69, wherein the body has a fracture toughness of no greater than 5.0 MPa m1/2, or no greater than 4.9 MPa m1/2, or no greater than 4.8 MPa m1/2, or no greater than 4.7 MPa m1/2, or no greater than 4.6 MPa m1/2, or no greater than 4.5 MPa m1/2.

Embodiment 133. The method of embodiment 69, wherein the body has a 4 pt flexural strength of at least 100 MPa, or at least 110 MPa, or at least 120 MPa, or at least 130 MPa, or at least 140 MPa, or at least 150 MPa, or at least 160 MPa, or at least 170 MPa, or at least 180 MPa, or at least 190 MPa, or at least 200 MPa, or at least 210 MPa, or at least 220 MPa.

Embodiment 134. The method of embodiment 69, wherein the body has a 4 pt flexural strength of no greater than 400 MPa, or no greater than 380 MPa, or no greater than 360 MPa, or no greater than 340 MPa, or no greater than 320 MPa, or no greater than 300 MPa, or no greater than 280 MPa, or no greater than 260 MPa.

Embodiment 135. The method of embodiment 69, wherein the body has an MOE of at least 100 GPa, or at least 125 GPa, or at least 150 GPa, or at least 175 GPa, or at least 200 GPa, or at least 225 GPa, or at least 250 GPa, or at least 275 GPa, or at least 300 GPa, at least 325 GPa, or at least 350 GPa.

Embodiment 136. The method of embodiment 69, wherein the body has an MOE of no greater than 700 GPa, or no greater than 675 GPa, or no greater than 650 GPa, or no greater than 625 GPa, or no greater than 600 GPa, or no greater than 575 GPa, or no greater than 550 GPa, or no greater than 525 GPa, or no greater than 500 GPa, or no greater than 475 GPa, or no greater than 450 GPa.

Embodiment 137. The method of embodiment 69, wherein the body has a ballistic limit velocity V50 of at least 767 m/s, or at least 768 m/s, or at least 769 m/s, or at least 770 m/s, or at least 771 m/s, or at least 772 m/s, or at least 773 m/s, or at least 774 m/s, or at least 775 m/s, or at least 776 m/s, or at least 777 m/s, or at least 778 m/s, or at least m/s, or at least 779 m/s, or at least 780 m/s, or at least 781 m/s, or at least 782 m/s, or at least 783 m/s, or at least 784 m/s, or at least 785 m/s.

Embodiment 138. The method of embodiment 69, wherein the body has a ballistic limit velocity V50 of not greater than 900 m/s, or not greater than 875 m/s, or not greater than 850 m/s, or not greater than 840 m/s, or not greater than 830 m/s, or not greater than 820 m/s, or not greater than 815 m/s, or not greater than 810 m/s, or not greater than 805 m/s, or not greater than 800 m/s.

Embodiment 139. The method of embodiment 69, wherein the article is an article of any one of embodiments 1-68.

Embodiment 140. The method of embodiment 69, wherein the pore formers comprise PMMA.

Embodiment 141. The method of embodiment 69, wherein the mixture comprises at least 0.05% pore formers or at least 0.10% pore formers or at least 0.15% pore formers or at least 0.20% pore formers or at least 0.25% pore formers or at least 0.30% pore formers or at least 0.35% pore formers or at least 0.40% pore formers or at least 0.45% pore formers or at least 0.50% pore formers or at least 0.55% pore formers or at least 0.60% pore formers or at least 0.65% pore formers or at least 0.70% pore formers.

Embodiment 142. The method of embodiment 69, wherein the mixture comprises no greater than 1.9% pore formers or no greater than 1.8% pore formers or no greater than 1.7% pore formers or no greater than 1.6% pore formers or no greater than 1.5% pore formers or no greater than 1.4% pore formers or no greater than 1.3% pore formers or no greater than 1.2% pore formers or no greater than 1.1% pore formers or no greater than 1.0% pore formers or no greater than 0.9% pore formers or no greater than 0.8% pore formers.

Embodiment 143. The method of embodiment 69, wherein the pore formers comprise a mean size of at least 40 microns or at least 41 microns or at least 42 microns or at least 43 microns or at least 44 microns or at least 45 microns or at least 46 microns or at least 47 microns or at least 48 microns or at least 49 microns or at least 50 microns or at least 51 microns or at least 52 microns or at least 53 microns or at least 54 microns or at least 55 microns or at least 56 microns or at least 57 microns or at least 58 microns or at least 59 microns or at least 61 microns or at least 61 microns or at least 62 microns or at least 63 microns.

Embodiment 144. The method of embodiment 69, wherein the pore formers comprise a mean size of no greater than 80 microns or no greater than 79 microns or no greater than 78 microns or no greater than 77 microns or no greater than 76 microns or no greater than 75 microns.

Embodiment 145. The method of embodiment 69, wherein the pore formers comprise a pore size distribution having a 5^{th} percentile, D5pf, of at least 40 microns or at least 41 microns or at least 42 microns or at least 43 microns or at least 44 microns or at least 45 microns or at least 46 microns or at least 47 microns or at least 48 microns or at least 49 microns or at least 50 microns or at least 51 microns or at least 52 microns or at least 53 microns or at least 54 microns or at least 55 microns or at least 56 microns or at least 57 microns or at least 58 microns or at least 59 microns or at least 61 microns or at least 61 microns or at least 62 microns or at least 63 microns.

Embodiment 146. The method of embodiment 69, wherein the pore formers comprise a pore size distribution having a 5^{th} percentile, D5pf, of no greater than 80 microns or no greater than 79 microns or no greater than 78 microns or no greater than 77 microns or no greater than 76 microns or no greater than 75 microns or no greater than 74 microns or no greater than 73 microns or no greater than 72 microns or no greater than 71 microns or no greater than 70 microns or no greater than 69 microns or no greater than 68 microns or no greater than 67 microns or no greater than 66 microns or no greater than 65.

Embodiment 147. The method of embodiment 69, wherein the pore formers comprise a pore size distribution having a 95^{th} percentile, D95pf, of at least 65 microns or at least 66 microns or at least 67 microns or at least 68 microns or at least 69 microns or at least 70 microns or at least 71 microns or at least 72 microns or at least 73 microns or at least 74 microns or at least 75 microns or at least 76 microns or at least 77 microns or at least 78 microns or at least 79 microns.

Embodiment 148. The method of embodiment 69, wherein the pore formers comprise a pore size distribution having a 95^{th} percentile, D95pf, of no greater than 100 microns or no greater than 99 microns or no greater than 98 microns or no greater than 97 microns or no greater than 96 microns or no greater than 95 microns or no greater than 94 microns or no greater than 93 microns or no greater than 92 microns or no greater than 91 microns or no greater than 90 microns or no greater than 89 microns or no greater than 88 microns or no greater than 87 microns or no greater than 86 microns or no greater than 85 microns or no greater than 84 microns or no greater than 83 microns or no greater than 82 microns or no greater than 81 microns or no greater than 80.

The embodiments provide a combination of features, which can be combined in various matters to describe and define a method and system of the embodiments. The description is not intended to set forth a hierarchy of features, but different features that can be combined in one or more manners to define the invention. In the foregoing, reference to specific embodiments and the connection of certain components is illustrative. It will be appreciated that reference to components as being coupled or connected is intended to disclose either direct connected between said components or indirect connection through one or more intervening components as will be appreciated to carry out the methods as discussed herein.

As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents and shall not be restricted or limited by the foregoing detailed description.

The disclosure is submitted with the understanding that it will not be used to interpret or limit the scope or meaning of the claims. In addition, in the foregoing disclosure, various features may be grouped together or described in a single embodiment for the purpose of streamlining the disclosure. This disclosure is not to be interpreted as reflecting an intention that the embodiments herein limit the features provided in the claims, and moreover, any of the features described herein can be combined together to describe the inventive subject matter. Still, inventive subject matter may be directed to less than all features of any of the disclosed embodiments.

### EXAMPLES

### Example 1

A suitable number of samples were created according to the following description to be analyzed as provided below. Alpha silicon carbide grains (avg size 0.8-1 micron) were mixed with 0.5 wt. % sintering aid (B₄C) and 11.5 wt. % binder. The mixture was spray dried to form a SiC premix. The SiC premix was combined with 0.75% by weight PMMA beads (63-75 microns) and blended in a double cone blender for 30 minutes to form a blended mixture. The blended mixture was pressed into green bodies. The green bodies were sintered at a sintering temperature of 2150° C. being for 3 hours.

### Comparative Example 1

A suitable number of samples were created according to the following description to be analyzed as provided below. Alpha silicon carbide grains (avg size 0.8-1 micron) were mixed with 0.5 wt. % sintering aid (B₄C) and 11.5 wt. % binders. The mixture was spray dried to form a SiC premix. The SiC premix was combined with 1.914% by weight PMMA beads (40-80 microns) and blended in a double cone blender for 30 minutes to form a blended. The blended mixture was pressed into green bodies. The green bodies were sintered at a sintering temperature of 2150° C. being for 3 hours.

### Pore Spacing Analysis

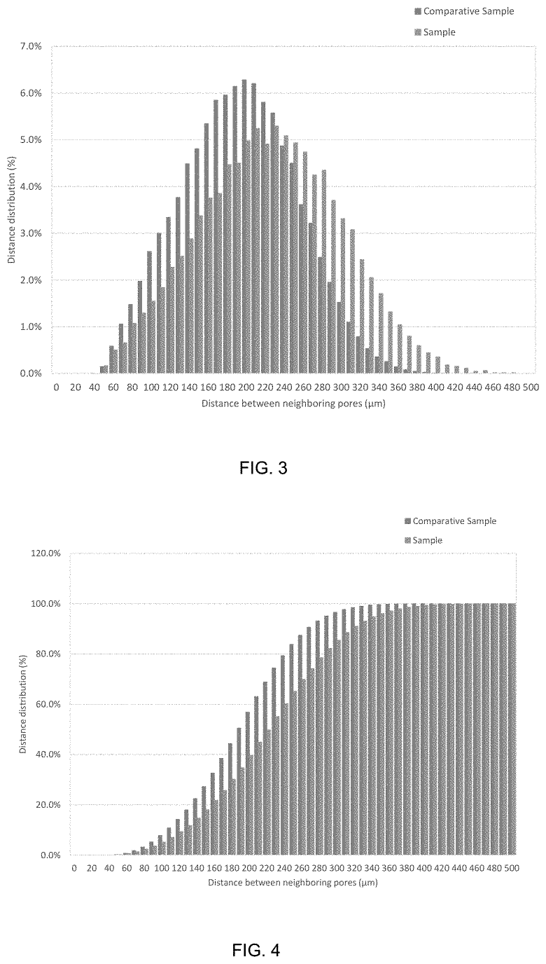

3×3×4 mm³ samples prepared according to example 1 and comparative example 1 were prepared and imaged in 3D with a resolution of 3 μm/voxel using to an X-ray computed-tomography scanner (VTomeX from GE). The pore detection was based on a grey level segmentation. For each sample, more than 5000 pores were detected and analyzed. Neighboring pores were identified using Delaunay triangulation (See Golias, N. A., & Dutton, R. W. (1997). Delaunay triangulation and 3D adaptive mesh generation. Finite elements in analysis and design, 25(3-4), 331-341.) Pore sizes and distance between neighboring pores were measured and the distributions were plotted. A distribution of the pore spacing can be found in FIG. 3. A cumulative distribution of the pore spacing can be found in FIG. 4. Certain percentiles within the pore spacing distribution can be found below.

TABLE 1

| | | Comparative | | | Comparative |
|---|---|---|---|---|---|
| | Sample | Sample | | Sample | Sample |
| V₅₀ | 789 m/s | 765 m/s | D05d | ~100 microns | ~90 microns |
| Porosity | 2.5%-3.74% | 3.74%-6.5% | D10d | ~120 microns | ~110 microns |
| Density | 3.09-3.13 g/cc | 3.0-3.09 g/cc | D25d | ~170 microns | ~145 microns |
| D50p | 50 microns | 62 microns | D75d | ~270 microns | ~230 microns |
| Mean Pore Spacing | 230 microns | 199 Microns | D90d | ~315 microns | ~270 microns |
| Median Pore Spacing (D50d) | ~220 microns | ~190 Microns | D95d | ~340 microns | ~290 microns |
| $\frac{mean pore spacing}{D 50 p}$ | 4.6 | 3.2 | $\frac{D 50 d}{D 50 p}$ | 4.4 | 3.1 |

### Ballistic Analysis

Eight 100×100×7 mm³ samples and 8 100×100×7 mm³ comparative samples were prepared and adhered to 200×200×5 mm³ aluminum backings. Each ceramic-metal assembly was exposed to ballistic impact from a distance of 15 meters with 7.62×51 P80 (steel core) ammunition at different speeds. Each steel-core either was stopped by the ceramic-metal assembly or perforated the assembly. The perforation data was plotted as a function of projectile velocity, with perforation being plotted as 1, and no perforation being plotted as a zero. The data was then fit to the inverse logit function, and the median velocity V50 was determined. The samples of Example 1 produced a V50 of 789 m/s while the samples of Comparative Example 1 produced a V50 of 765 m/s. It is believed that the improvements disclosed herein will improve ballistic protection performance for the materials disclosed herein, over multiple impacts.

What is claimed is:

1. An article comprising:
a body including:
a first phase comprising alpha silicon carbide; and
pores contained in the body, the pores having a mean spacing distance of at least 205 microns and not greater than 300.

2. The article of claim 1, wherein the body comprises 0.5 vol % and not greater than 4 vol % porosity.

3. The article of claim 1, comprising a ballistic limit velocity V₅₀ of at least 766 m/s.

4. The article of claim 1, wherein the ratio of the median pore spacing to median pore size,
$$\frac{D 50 d}{D 50 p} ,$$
is at least 3.2.

5. The article of claim 1, wherein the pores have a median size, D50p, of at least 10 microns and no greater than 100 microns.

6. The article of claim 1, wherein the pores have a spacing distance standard deviation of not greater than 90.

7. The article of claim 1, wherein the median distance between the pores D50d, is at least 190 microns and not greater than 500 microns.

8. The article of claim 1, wherein the body comprises at least 90 wt. % SiC for a total weight of the body. 9 The article of claim 1, wherein a majority of the silicon carbide within in the body is alpha phase silicon carbide, or at least 60 wt. % of all silicon carbide in the body is alpha phase silicon carbide.

10. The article of claim 1, wherein the body comprises a boron-containing material in an amount of at least 0.1 wt. % and not greater than 5 wt. % for a total weight of the body.

11. The article of claim 10, wherein the boron-containing material includes boron carbide.

11. The article of claim 1, wherein the ratio of the mean pore spacing to median pore size,
$$\frac{mean pore spacing}{D 50 p} ,$$
is at least 1.0 and not greater than 10.

12. The article of claim 1, wherein the ratio of the median pore spacing to median pore size,
$$\frac{D 50 d}{D 50 p} ,$$
is not greater than 10, or not greater than 9, or not greater than 8, or not greater than 7, or not greater than 6, or not greater than 5.

13. The article of claim 1, wherein at least 50% of all porosity is closed porosity.

14. The article of claim 1, wherein the body comprises a density of at least 2.00 g/cm³ and no greater than 4.00 g/cm³.

15. The article of claim 1, wherein the body has a hardness of at least 2000 Knoop and not greater than 3500 Knoop.

16. The article of claim 1, wherein the body has a fracture toughness of at least 3.0 MPa m^{1/2} and no greater than 5.0 MPa m^{1/2}.

17. The article of claim 1, wherein the body has a 4 pt flexural strength of at least 100 MPa and no greater than 400 MPa.

18. The article of claim 1, wherein the body has an MOE of at least 100 GPa and no greater than 700 GPa.

19. The article of claim 1, wherein the body has a ballistic limit velocity V₅₀ of not greater than 900 m/s.
